(19) United States
(12) Patent Application Publication
(10) Pub. No.: US 2024/0265820 A1
(43) Pub. Date: Aug. 8, 2024

(54) METHODS AND SYSTEMS FOR PROVIDING INTEGRATED OPERATOR TRAINING AND OPERATOR ASSISTANCE IN REMOTE OPERATION FACILITIES

(71) Applicant: HONEYWELL INTERNATIONAL INC., Charlotte, NC (US)

(72) Inventors: Viraj Srivastava, Bengaluru (IN); Praveen Sam, Cypress, TX (US); Niranjan Amrutur Subba Rao, Bangalore (IN)

(21) Appl. No.: 18/420,780

(22) Filed: Jan. 24, 2024

(30) Foreign Application Priority Data
Jan. 27, 2023 (IN) 202311005478

(51) Int. Cl. G09B 5/02; G06N 20/00; G06Q 10/0633

(52) U.S. Cl. CPC G09B 5/02; G06N 20/00; G06Q 10/0633

(57) ABSTRACT

Example methods, apparatuses, systems, and computer program products are provided. For example, an example computer-implemented method includes receiving a plurality of runtime facility process variable indicators and a plurality of runtime derived process metric indicators, receiving a facility state tree data object that comprises a plurality of facility state tree nodes corresponding to a plurality of facility state indicators; generating a runtime facility state indicator, generating a runtime facility score indicator associated with the runtime facility state indicator, and generating a remote operator assistance data object associated with the facility indicator.

### CROSS REFERENCE TO RELATED APPLICATIONS

This application claims the benefit of priority of IN Patent Application No. 202311005478, titled “METHODS AND SYSTEMS FOR PROVIDING INTEGRATED OPERATOR TRAINING AND OPERATOR ASSISTANCE IN REMOTE OPERATION FACILITIES”, filed on Jan. 27, 2023, which is herein incorporated by reference in its entirety.

### FIELD OF THE INVENTION

Example embodiments of the present disclosure relate generally to autonomous systems. For example, example embodiments of the present disclosure may be implemented to provide training and assistance to operators in remote operation facilities.

### BACKGROUND

Applicant has identified many technical challenges and difficulties associated with manufacturing devices, systems, and methods, including, but not limited to, devices, systems, and methods associated with training and assisting operators in remote operation facilities.

### BRIEF SUMMARY

Various embodiments described herein relate to methods, apparatuses, and systems for training and assisting operators in remote operation facilities are provided.

In accordance with various embodiments of the present disclosure, an apparatus is provided. In some embodiments, the apparatus comprises at least one processor and at least one non-transitory memory comprising a computer program code. In some embodiments, the at least one non-transitory memory and the computer program code are configured to, with the at least one processor, cause the apparatus to receive a plurality of runtime facility process variable indicators and a plurality of runtime derived process metric indicators that are associated with a facility indicator, receive a facility state tree data object that is associated with the facility indicator and comprises a plurality of facility state tree nodes corresponding to a plurality of facility state indicators, generate a runtime facility state indicator based at least in part on the plurality of runtime facility process variable indicators, the plurality of runtime derived process metric indicators, and the facility state tree data object, generate a runtime facility score indicator associated with the runtime facility state indicator based at least in part on the plurality of runtime facility process variable indicators and the plurality of runtime derived process metric indicators, and generate a remote operator assistance data object associated with the facility indicator based at least in part on the runtime facility state indicator, the runtime facility score indicator, and one or more machine learning models.

In some embodiments, the facility indicator is associated with a plurality of facility unit indicators. In some embodiments, the plurality of runtime facility process variable indicators and the plurality of runtime derived process metric indicators are associated with at least one of the plurality of facility unit indicators.

In some embodiments, the plurality of facility state indicators comprises a facility normal state indicator, a facility low throughput state indicator, and a facility upset state indicator.

In some embodiments, prior to receiving the facility state tree data object, the at least one non-transitory memory and the computer program code are configured to, with the at least one processor, cause the apparatus to: receive a plurality of historical facility process variable indicators and a plurality of historical derived process metric indicators that are associated with the facility indicator, generate the facility state tree data object based at least in part on the plurality of historical facility process variable indicators and the plurality of historical derived process metric indicators, and store the facility state tree data object in a remote operator assistance data repository.

In some embodiments, when generating the facility state tree data object, the at least one non-transitory memory and the computer program code are configured to, with the at least one processor, cause the apparatus to: input the plurality of historical facility process variable indicators and the plurality of historical derived process metric indicators to a facility steady state determination machine learning model, receive, from the facility steady state determination machine learning model, a plurality of steady state facility process variable indicators and a plurality of steady state derived process metric indicators, and associate each of the plurality of steady state derived process metric indicators with one of the plurality of facility state indicators.

In some embodiments, the plurality of facility state tree nodes comprises a plurality of historical facility score indicators. In some embodiments, the at least one non-transitory memory and the computer program code are configured to, with the at least one processor, cause the apparatus to: generate a historical facility score indicator associated with each of the plurality of facility state indicators based at least in part on the plurality of historical facility process variable indicators and the plurality of historical derived process metric indicators.

In some embodiments, when generating the historical facility score indicator, the at least one non-transitory memory and the computer program code are configured to, with the at least one processor, cause the apparatus to: generate a plurality of historical facility state index indicators based at least in part on the plurality of historical facility process variable indicators and the plurality of historical derived process metric indicators, receive a plurality of historical state index weight indicators associated with the plurality of historical facility state index indicators, and generate the historical facility score indicator based at least in part on the plurality of historical facility state index indicators and the plurality of historical state index weight indicators.

In some embodiments, the plurality of historical facility state index indicators comprises a historical alarm system performance index indicator, a historical overall operation performance index indicator, a historical field performance index indicator, a historical relative control performance index indicator, and a historical safety performance index indicator.

In some embodiments, the facility state tree data object comprises a plurality of facility state tree branches connecting the plurality of facility state tree nodes.

In some embodiments, the at least one non-transitory memory and the computer program code are configured to, with the at least one processor, cause the apparatus to: input, to a facility state change prediction machine learning model, the plurality of historical facility process variable indicators and the plurality of historical derived process metric indicators, receive, from the facility state change prediction machine learning model, a plurality of predicted facility state change likelihood indicators associated with the plurality of facility state indicators, and generate the plurality of facility state tree branches based at least in part on the plurality of predicted facility state change likelihood indicators.

In some embodiments, when generating the runtime facility state indicator, the at least one non-transitory memory and the computer program code are configured to, with the at least one processor, cause the apparatus to: input, to a facility steady state determination machine learning model, the plurality of runtime facility process variable indicators and the plurality of runtime derived process metric indicators, receive, from the facility steady state determination machine learning model, one or more runtime steady state facility process variable indicators and one or more runtime steady state derived process metric indicators, and identify a facility state tree node from the plurality of facility state tree nodes based at least in part on the one or more runtime steady state facility process variable indicators and the one or more runtime steady state derived process metric indicators.

In some embodiments, when generating the runtime facility score indicator, the at least one non-transitory memory and the computer program code are configured to, with the at least one processor, cause the apparatus to: generate a plurality of runtime facility state index indicators based at least in part on the plurality of runtime facility process variable indicators and the plurality of runtime derived process metric indicators, determine a plurality of runtime state index weight indicators associated with the plurality of runtime facility state index indicators, and generate the runtime facility score indicator based at least in part on the plurality of runtime facility state index indicators and the plurality of runtime state index weight indicators.

In some embodiments, the facility state tree data object comprises a plurality of facility state tree branches connecting the plurality of facility state tree nodes. In some embodiments, the plurality of facility state tree branches are associated with a plurality of historical remote operator action indicators.

In some embodiments, when generating the remote operator assistance data object, the at least one non-transitory memory and the computer program code are configured to, with the at least one processor, cause the apparatus to: determine a plurality of child facility state tree nodes that is connected to a facility state tree node corresponding to the runtime facility state indicator, determine a plurality of facility score indicators associated with the plurality of child facility state tree nodes, select a child facility state tree node from the plurality of child facility state tree nodes that is associated with a highest facility score indicator among the plurality of facility score indicators, and determine at least one historical remote operator action indicator associated with a facility state tree branch that connects the facility state tree node and the child facility state tree node.

In some embodiments, when generating the remote operator assistance data object associated with the facility indicator, the at least one non-transitory memory and the computer program code are configured to, with the at least one processor, cause the apparatus to: input the runtime facility state indicator, the runtime facility score indicator, and the facility state tree data object to a facility deterioration prediction machine learning model, receive a predicted facility deterioration indicator from the facility deterioration prediction machine learning model, and determine whether the predicted facility deterioration indicator satisfies a facility deterioration threshold indicator.

In some embodiments, the at least one non-transitory memory and the computer program code are configured to, with the at least one processor, cause the apparatus to: in response to determining that the predicted facility deterioration indicator does not satisfy the facility deterioration threshold indicator, generate a facility deterioration alert indicator.

In accordance with various embodiments of the present disclosure, a computer-implemented method is provided. In some embodiments, the computer-implemented method comprises receiving a plurality of runtime facility process variable indicators and a plurality of runtime derived process metric indicators that are associated with a facility indicator, receiving a facility state tree data object that is associated with the facility indicator and comprises a plurality of facility state tree nodes corresponding to a plurality of facility state indicators, generating a runtime facility state indicator from the plurality of facility state indicators based at least in part on the plurality of runtime facility process variable indicators, the plurality of runtime derived process metric indicators, and the facility state tree data object, generating a runtime facility score indicator associated with the runtime facility state indicator based at least in part on the plurality of runtime facility process variable indicators and the plurality of runtime derived process metric indicators, and generating a remote operator assistance data object associated with the facility indicator based at least in part on the runtime facility state indicator, the runtime facility score indicator, and one or more machine learning models.

In accordance with various embodiments of the present discourse, a computer program product is provided. In some embodiments, the computer program product comprises at least one non-transitory computer-readable storage medium having computer-readable program code portions stored therein. In some embodiments, the computer-readable program code portions comprises an executable portion configured to receive a plurality of runtime facility process variable indicators and a plurality of runtime derived process metric indicators that are associated with a facility indicator, receive a facility state tree data object that is associated with the facility indicator and comprises a plurality of facility state tree nodes corresponding to a plurality of facility state indicators, generate a runtime facility state indicator from the plurality of facility state indicators based at least in part on the plurality of runtime facility process variable indicators, the plurality of runtime derived process metric indicators, and the facility state tree data object, generate a runtime facility score indicator associated with the runtime facility state indicator based at least in part on the plurality of runtime facility process variable indicators and the plurality of runtime derived process metric indicators, and generate a remote operator assistance data object associated with the facility indicator based at least in part on the runtime facility state indicator, the runtime facility score indicator, and one or more machine learning models.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 is an example system architecture diagram illustrating an example integrated remote operation system in accordance with some embodiments of the present disclosure;

FIG. 2 is an example system architecture diagram illustrating an example integrated training and operator assistance computing device in accordance with some embodiments of the present disclosure;

FIG. 3 illustrates an example machine learning model based integrated training and operator assistance method that provides various technical improvements and advantages in accordance with some embodiments of the present disclosure;

FIG. 4 illustrates an example facility state tree data object in accordance with some embodiments of the present disclosure;

FIG. 5 illustrates an example machine learning model based integrated training and operator assistance method that provides various technical improvements and advantages in accordance with some embodiments of the present disclosure;

FIG. 6 illustrates an example machine learning model based integrated training and operator assistance method that provides various technical improvements and advantages in accordance with some embodiments of the present disclosure;

FIG. 7 illustrates an example machine learning model based integrated training and operator assistance method that provides various technical improvements and advantages in accordance with some embodiments of the present disclosure;

FIG. 8 illustrates an example machine learning model based integrated training and operator assistance method that provides various technical improvements and advantages in accordance with some embodiments of the present disclosure;

FIG. 9 illustrates an example machine learning model based integrated training and operator assistance method that provides various technical improvements and advantages in accordance with some embodiments of the present disclosure;

FIG. 10 illustrates an example machine learning model based integrated training and operator assistance method that provides various technical improvements and advantages in accordance with some embodiments of the present disclosure;

FIG. 11 illustrates an example machine learning model based integrated training and operator assistance method that provides various technical improvements and advantages in accordance with some embodiments of the present disclosure;

FIG. 12 illustrates an example machine learning model based integrated training and operator assistance method that provides various technical improvements and advantages in accordance with some embodiments of the present disclosure; and

FIG. 13 illustrates an example machine learning model based integrated training and operator assistance method that provides various technical improvements and advantages in accordance with some embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The term “electronically coupled,” “electronically coupling,” “electronically couple,” “in communication with,” “in electronic communication with,” or “connected” in the present disclosure refers to two or more elements or components being connected through wired means and/or wireless means, such that signals, electrical voltage/current, data and/or information may be transmitted to and/or received from these elements or components.

As described above, there are many technical challenges and difficulties associated with manufacturing devices, systems, and methods for training and assisting operators in remote operation facilities. For example, many devices, systems, and methods fail to provide safety and reliability guarantees when assisting operators in remote operation facilities.

Various embodiments of the present disclosure overcome these technical challenges and difficulties, and provide various technical improvements and advantages. For example, various embodiments of the present disclosure implement one or more machine learning models that generate facility state tree data objects, generate runtime facility state indicators and runtime facility score indicators based at least in part on the facility state tree data objects, and generate remote operator assistance data objects based at least in part on the runtime facility state indicators and runtime facility score indicators. Various embodiments of the present disclosure provide shared situational awareness between operations centers and the field to improve worker safety and performance.

In the present disclosure, the term “data object” refers to a data structure that represents one or more functionalities and/or characteristics associated with data and/or information (for example, but not limited to, data and/or information associated with one or more remote operation facilities). In some embodiments, a data object may be generated by a combination of one or more software (for example, one or more computer programs) and/or one or more hardware (for example, one or more servers and/or one or more client devices). In some embodiments, a data object may provide a functional unit for one or more computer programs.

In the present disclosure, the term “indicator” refers to digital data that may describe or is associated with one or more attributes, one or more data fields associated with a system (such as, but not limited to, one or more remote operation facilities as described herein).

In the present disclosure, the term “facility indicator” refers to an indicator that represents, indicates, and/or comprises an operation facility identifier of an operation facility such as, but not limited to, a remote operation facility. Examples of operation facilities may include, but are not limited to, manufacturing plants, factories, production plants, and/or the like. For example, a manufacturing plant may be a remote operation facility where remote control of the manufacturing operations are enabled. In such an example, there is no need for an operator to be at the manufacturing plant. Instead, one or more operators may need to be a part of an autonomous manufacturing loop in case where a part of the manufacturing plant needs control instructions from the one or more operators. In some embodiments, the facility indicator may be in the form of text string(s), numerical character(s), alphabetical character(s), alphanumeric code(s), ASCII character(s), and/or the like.

In the present disclosure, the term “facility unit indicator” refers to an indicator that represents, indicates, and/or comprises an operation facility unit identifier of an operation facility such as, but not limited to, remote operation facility. In some embodiments, an example operation facility may comprise multiple units, and each unit of the operation facility is associated with a facility unit indicator. For example, an example manufacturing plant may comprise units such as, but not limited to, one or more raw material processing units, one or more assembly line units, one or more packaging units, one or more distribution units, one or more storage units, and/or the like. In some embodiments, the facility unit indicator may be in the form of text string(s), numerical character(s), alphabetical character(s), alphanumeric code(s), ASCII character(s), and/or the like.

In the present disclosure, the term “facility state indicator” refers to an indicator that represents, indicates, and/or comprises data and/or information associated with the overall state of the facility and/or one or more units of the facility. In some embodiments, the facility state indicator may be in the form of text string(s), numerical character(s), alphabetical character(s), alphanumeric code(s), ASCII character(s), and/or the like.

In accordance with various embodiments of the present disclosure, examples of facility state indicators may be associated with different types, and each type of facility state indicator corresponds to a state of the facility. Example types of facility unit indicators may include, but are not limited to, facility low throughput state indicators, facility normal state indicators, facility upset state indicators, and/or the like.

In the present disclosure, the term “facility low throughput state indicator” refers to a type of facility state indicator that represents, indicates, and/or comprises data and/or information associated with a low throughput state of the facility. For example, the facility may provide a throughput that is lower than a target throughput. In some embodiments, the facility low throughput state indicator may be in the form of text string(s), numerical character(s), alphabetical character(s), alphanumeric code(s), ASCII character(s), and/or the like.

In the present disclosure, the term “facility normal state indicator” refers to a type of facility state indicator that represents, indicates, and/or comprises data and/or information associated with a normal state of the facility. In some embodiments, the facility normal state indicator may be in the form of text string(s), numerical character(s), alphabetical character(s), alphanumeric code(s), ASCII character(s), and/or the like.

In the present disclosure, the term “facility upset state indicator” refers to a type of facility state indicator that represents, indicates, and/or comprises data and/or information associated with an upset state of the facility. For example, one or more processes and/or operations associated with the facility may be abnormal when the facility is in an upset state. In some embodiments, the facility upset state indicator may be in the form of text string(s), numerical character(s), alphabetical character(s), alphanumeric code(s), ASCII character(s), and/or the like.

While the description above provides example types of facility state indicators that include facility low throughput state indicators, facility normal state indicators, and facility upset state indicators, it is noted that the scope of the present disclosure is not limited to the description above. In some examples, an example facility state indicator may comprise one or more additional and/or alternative types of facility state indicators.

In the present disclosure, the term “facility score indicator” refers to an indicator that represents, indicates, and/or comprises a facility score that quantitatively indicates the overall operation and performance level associated with the facility. For example, the higher the facility score, the better the performance associated with the facility, and the more desirable to operate in the facility. In some embodiments, the facility score indicator may be in the form of text string(s), numerical character(s), alphabetical character(s), alphanumeric code(s), ASCII character(s), and/or the like.

In the present disclosure, the term “facility state tree data object” refers to a type of data object that represents, indicates, and/or comprises data and/or information associated with different operation states of the facility, as well as data and/or information associated with transitions between different operation states of the facility.

For example, the facility state tree data object may comprise a plurality of facility state tree nodes and a plurality of facility state tree branches. In such an example, each of the plurality of facility state tree branches connects two of the plurality of facility state tree nodes.

In the present disclosure, the term “facility state tree node” refers to a data element of a facility state tree data object that corresponds to a facility state indicator. For example, an example facility state tree data object in accordance with some embodiments of the present disclosure may comprise one or more facility state tree nodes that correspond to one or more facility low throughput state indicators, one or more facility state tree nodes that correspond to one or more facility normal state indicators, and/or one or more facility state tree nodes that correspond to one or more facility upset state indicators.

While the description above provides example facility state indicators that may correspond to facility state tree nodes, it is noted that the scope of the present disclosure is not limited to the description above. In some examples, an example facility state tree node may comprise one or more additional and/or alternative facility state indicators.

In the present disclosure, the term “facility state tree branch” refers to a data element of a facility state tree data object that connects two facility state tree nodes and represents a transaction from a parent facility state tree node to a child facility state tree node. For example, an example facility state tree branch may be associated with a historical remote operator action indicator. In such an example, the historical remote operator action indicator indicates one or more actions by the remote operator that cause the transition of the facility state indicators. Additional details associated with the facility state tree branch are described herein.

In the present disclosure, the term “runtime facility process variable indicator” refers to an indicator that represents, indicates, and/or comprises data and/or information associated with one or more variables and/or parameters associated with one or more processes and/or operations in the facility during runtime. For example, an example runtime facility process variable indicator may represent, indicate, and/or comprise data and/or information associated with temperatures and/or pressures in a distillation column during runtime. Additionally, or alternatively, an example runtime facility process variable indicator may represent, indicate, and/or comprise data and/or information associated with the cutting speed and/or feeding rate associated with a cutting operation in the facility during runtime. Additionally, or alternatively, the runtime facility process variable indicator may present, indicate, and/or comprise data and/or information associated with other variables and/or parameters associated with one or more processes and/or operations in the facility during runtime. In some embodiments, the runtime facility process variable indicator may be in the form of text string(s), numerical character(s), alphabetical character(s), alphanumeric code(s), ASCII character(s), and/or the like.

In the present disclosure, the term “runtime derived process metric indicator” refers to an indicator that represents, indicates, and/or comprises data and/or information associated with one or more process metrics associated with the facility during runtime. In some embodiments, an example runtime derived process metric indicator may be derived based on one or more runtime facility process variable indicators associated with the facility. For example, an example runtime derived process metric indicator may comprise data and/or information that determine which runtime derived process metric indicator(s) to analyze in determining the process metric associated with the facility, as well as the priority in analyzing the runtime derived process metric indicator(s).

For example, an example runtime derived process metric indicator may comprise data and/or information associated with one or more key performance indicators such as, but not limited to, quality, production, performance assessment, cost prediction, and/or the like. As another example, an example runtime derived process metric indicator may comprise data and/or information associated with deviations from setpoints (for example, one or more desired values associated with one or more parameters of the operation facility). As another example, an example runtime derived process metric indicator may comprise data and/or information associated with parameter oscillations (such as, but not limited to, one or more values associated with one or more parameters of the operation facility that are oscillating). Additionally, or alternatively, an example runtime derived process metric indicator may comprise other derived data and/or information associated with the operation facility.

In some embodiments, the runtime derived process metric indicator may be in the form of text string(s), numerical character(s), alphabetical character(s), alphanumeric code(s), ASCII character(s), and/or the like.

In the present disclosure, the term “runtime facility state indicator” refers to an indicator that represents, indicates, and/or comprises data and/or information associated with the overall state of the facility and/or one or more units of the facility during runtime. In some embodiments, the runtime facility state indicator may be in the form of text string(s), numerical character(s), alphabetical character(s), alphanumeric code(s), ASCII character(s), and/or the like.

Similar to the facility state indicators described above, examples of runtime facility state indicators may be associated with different types, and each type of runtime facility state indicator corresponds to a runtime state of the facility. Example types of runtime facility unit indicators may include, but are not limited to, runtime facility low throughput state indicators, runtime facility normal state indicators, runtime facility upset state indicators, and/or the like.

In the present disclosure, the term “historical facility process variable indicator” refers to an indicator that represents, indicates, and/or comprises data and/or information associated with one or more variables and/or parameters associated with one or more processes and/or operations in the facility in the past. For example, an example historical facility process variable indicator may represent, indicate, and/or comprise data and/or information associated with temperatures and/or pressures in a distillation column in the past. Additionally, or alternatively, an example historical facility process variable indicator may represent, indicate, and/or comprise data and/or information associated with the cutting speed and/or feeding rate associated with a cutting operation in the facility in the past. Additionally, or alternatively, the historical facility process variable indicator may present, indicate, and/or comprise data and/or information associated with other variables and/or parameters associated with one or more processes and/or operations in the facility in the past. In some embodiments, the historical facility process variable indicator may be in the form of text string(s), numerical character(s), alphabetical character(s), alphanumeric code(s), ASCII character(s), and/or the like.

In the present disclosure, the term “historical derived process metric indicator” refers to an indicator that represents, indicates, and/or comprises one or more process metrics associated with the facility in the past. In some embodiments, an example historical derived process metric indicator may be derived based on one or more historical facility process variable indicators associated with the facility. For example, an example historical derived process metric indicator may comprise data and/or information that determines which historical derived process metric indicator(s) to analyze in determining the process metric associated with the facility, as well as the priority in analyzing the historical derived process metric indicator(s).

For example, an example historical derived process metric indicator may comprise data and/or information associated with one or more key performance indicators such as, but not limited to, quality, production, performance assessment, cost prediction, and/or the like. As another example, an example historical derived process metric indicator may comprise data and/or information associated with deviations from setpoints (for example, one or more desired values associated with one or more parameters of the operation facility). As another example, an example historical derived process metric indicator may comprise data and/or information associated with parameter oscillations (such as, but not limited to, one or more values associated with one or more parameters of the operation facility that are oscillating). Additionally, or alternatively, an example historical derived process metric indicator may comprise other derived data and/or information associated with the operation facility.

In some embodiments, the historical derived process metric indicator may be in the form of text string(s), numerical character(s), alphabetical character(s), alphanumeric code(s), ASCII character(s), and/or the like.

In the present disclosure, the term “facility state change prediction machine learning model” refers to a machine learning model that is trained to generate one or more predicted facility state change likelihood indicators as one or more outputs in response to receiving one or more historical facility process variable indicators and one or more historical derived process metric indicators as inputs.

In the present disclosure, the term “predicted facility state change likelihood indicator” refers to an indicator that represents, indicates, and/or comprises the likelihood that the facility transitions from one facility state to another facility state. In some embodiments, the predicted facility state change likelihood indicator may be in the form of text string(s), numerical character(s), alphabetical character(s), alphanumeric code(s), ASCII character(s), and/or the like.

For example, an example facility state change prediction machine learning model may comprise supervised machine learning algorithms. Examples of supervised machine learning algorithms may include, but are not limited to, classification models (such as, but not limited to, decision tree, random forest, and/or the like), regression models (such as, but not limited to, linear regression, logistic regression), and/or the like. In such an example, the facility state change prediction machine learning model may be trained under supervision by using one or more labeled datasets that comprise one or more historical facility process variable indicators and one or more historical derived process metric indicators and their corresponding known predicted facility state change likelihood indicators. During supervised training, the example facility state change prediction machine learning model may receive historical facility process variable indicators and historical derived process metric indicators from the one or more labeled datasets as inputs, and may adjust one or more parameters of its machine learning algorithms such that the predicted facility state change likelihood indicators from the example facility state change prediction machine learning model match the predicted facility state change likelihood indicators in the one or more labeled datasets.

As another example, an example facility state change prediction machine learning model may comprise unsupervised machine learning algorithms. Examples of unsupervised machine learning algorithms may include, but are not limited to, clustering models (such as, but not limited to, K-means clustering, hierarchical clustering, and/or the like), association models (such as, but not limited to, Apriori algorithm), and/or the like. In such an example, the facility state change prediction machine learning model may be trained by receiving one or more historical facility process variable indicators and one or more historical derived process metric indicators as an unlabeled dataset and identifying one or more patterns from the one or more historical facility process variable indicators and one or more historical derived process metric indicators to generate one or more predicted facility state change likelihood indicators as the outputs.

While the description above provides examples of facility state change prediction machine learning model, it is noted that the scope of the present disclosure is not limited to the description above. In some examples, an example facility state change prediction machine learning model may comprise one or more additional and/or alternative machine learning models. For example, an example facility state change prediction machine learning model may additionally or alternatively comprise support vector machine models, naive bayes models, artificial neural networks, and/or the like.

In the present disclosure, the term “historical facility score indicator” refers to an indicator that represents, indicates, and/or comprises a facility score that quantitatively indicates the overall operation and performance level associated with the facility at a past time point. In some embodiments, the historical facility score indicator may be in the form of text string(s), numerical character(s), alphabetical character(s), alphanumeric code(s), ASCII character(s), and/or the like.

In some embodiments, an example historical facility score indicator may be generated based on a plurality of historical facility state index indicators and a plurality of historical state index weight indicators. For example, the example historical facility score indicator may be a weight combination of the plurality of historical facility state index indicators, and the weight of each of the plurality of historical facility state index indicators is indicated by a historical state index weight indicator that corresponds to the historical facility state index indicator.

In the present disclosure, the term “historical facility state index indicator” refers to an indicator that represents, indicates, and/or comprises data and/or information associated with the operation and performance level associated with one aspect of the facility at a past time point. In some embodiments, the historical facility state index indicator may be in the form of text string(s), numerical character(s), alphabetical character(s), alphanumeric code(s), ASCII character(s), and/or the like.

In some embodiments, examples of historical facility state index indicators may be associated with different types. Example types of historical facility state index indicators may include, but are not limited to, historical alarm system performance index indicators, historical field performance index indicators, historical overall operation performance index indicators, historical relative control performance index indicators, historical safety performance index indicators, and/or the like.

In the present disclosure, the term “historical alarm system performance index indicator” refers to a type of historical facility state index indicator that represents, indicates, and/or comprises data and/or information associated with the performance level associated with the alarm systems of the facility in the past.

In some embodiments, the historical alarm system performance index indicator may categorize the performance level of the alarm systems of the facility as overloaded. In some embodiments, the historical alarm system performance index indicator may categorize the performance level of the alarm systems of the facility as reactive. In some embodiments, the historical alarm system performance index indicator may categorize the performance level of the alarm systems of the facility as stable. In some embodiments, the historical alarm system performance index indicator may categorize the performance level of the alarm systems of the facility as robust.

In some embodiments, the historical alarm system performance index indicator may be in the form of text string(s), numerical character(s), alphabetical character(s), alphanumeric code(s), ASCII character(s), and/or the like.

In the present disclosure, the term “historical field performance index indicator” refers to a type of historical facility state index indicator that represents, indicates, and/or comprises data and/or information associated with the performance level of field operations of the facility in the past. Examples of field operations may include, but are not limited to, fidelity to assigned manufacturing plans and/or the like.

In some embodiments, the historical field performance index indicator may categorize the performance level of the field operations of the facility as overloaded. In some embodiments, the historical field performance index indicator may categorize the performance level of the field operations of the facility as reactive. In some embodiments, the historical field performance index indicator may categorize the performance level of the field operations of the facility as stable. In some embodiments, the historical field performance index indicator may categorize the performance level of the field operations of the facility as robust.

In some embodiments, the historical field performance index indicator may be in the form of text string(s), numerical character(s), alphabetical character(s), alphanumeric code(s), ASCII character(s), and/or the like.

In the present disclosure, the term “historical overall operation performance index indicator” refers to a type of historical facility state index indicator that represents, indicates, and/or comprises data and/or information associated with the performance level of overall operations in the facility in the past.

In some embodiments, the historical overall operation performance index indicator may categorize the performance level of the overall operations of the facility as overloaded. In some embodiments, the historical overall operation performance index indicator may categorize the performance level of the overall operations of the facility as reactive. In some embodiments, the historical overall operation performance index indicator may categorize the performance level of the overall operations of the facility as stable. In some embodiments, the historical overall operation performance index indicator may categorize the performance level of the overall operations of the facility as robust.

In some embodiments, the historical overall operation performance index indicator may be in the form of text string(s), numerical character(s), alphabetical character(s), alphanumeric code(s), ASCII character(s), and/or the like.

In the present disclosure, the term “historical relative control performance index indicator” refers to a type of historical facility state index indicator that represents, indicates, and/or comprises data and/or information associated with the performance level of the control systems in the facility in the past.

In some embodiments, the historical relative control performance index indicator may categorize the performance level of the control systems of the facility as overloaded. In some embodiments, the historical relative control performance index indicator may categorize the performance level of the control systems of the facility as reactive. In some embodiments, the historical relative control performance index indicator may categorize the performance level of the control systems of the facility as stable. In some embodiments, the historical relative control performance index indicator may categorize the performance level of the control systems of the facility as robust.

In some embodiments, the historical relative control performance index indicator may be in the form of text string(s), numerical character(s), alphabetical character(s), alphanumeric code(s), ASCII character(s), and/or the like.

In the present disclosure, the term “historical safety performance index indicator” refers to a type of historical facility state index indicator that represents, indicates, and/or comprises data and/or information associated with the performance level of the safety systems in the facility in the past.

In some embodiments, the historical safety performance index indicator may categorize the performance level of the safety systems of the facility as overloaded. In some embodiments, the historical safety performance index indicator may categorize the performance level of the safety systems of the facility as reactive. In some embodiments, the historical safety performance index indicator may categorize the performance level of the safety systems of the facility as stable. In some embodiments, the historical safety performance index indicator may categorize the performance level of the safety systems of the facility as robust.

In some embodiments, the historical safety performance index indicator may be in the form of text string(s), numerical character(s), alphabetical character(s), alphanumeric code(s), ASCII character(s), and/or the like.

While the description above provides example types of historical facility state index indicators that include historical alarm system performance index indicators, historical field performance index indicators, historical overall operation performance index indicators, historical relative control performance index indicators, and historical safety performance index indicators, it is noted that the scope of the present disclosure is not limited to the description above. In some examples, an example historical facility state index indicator may comprise one or more additional and/or alternative types.

In the present disclosure, the term “historical state index weight indicator” refers to an indicator that represents, indicates, and/or comprises a weight associated with a corresponding historical facility state index indicator for generating the historical facility score indicator.

In some embodiments, a historical state index weight indicator is assigned to the historical alarm system performance index indicator, a historical state index weight indicator is assigned to the historical field performance index indicator, a historical state index weight indicator is assigned to the historical overall operation performance index indicator, a historical state index weight indicator is assigned to the historical relative control performance index indicator, and a historical state index weight indicator is assigned to the historical safety performance index indicator.

In some embodiments, the state index weight indicator may be in the form of text string(s), numerical character(s), alphabetical character(s), alphanumeric code(s), ASCII character(s), and/or the like.

In the present disclosure, the term “runtime facility score indicator” refers to an indicator that represents, indicates, and/or comprises a facility score that quantitatively indicates the overall operation and performance level associated with the facility during the runtime. In some embodiments, the runtime facility score indicator may be in the form of text string(s), numerical character(s), alphabetical character(s), alphanumeric code(s), ASCII character(s), and/or the like.

In some embodiments, an example runtime facility score indicator may be generated based on a plurality of runtime facility state index indicators and a plurality of runtime state index weight indicators. For example, the example runtime facility score indicator may be a weight combination of the plurality of runtime facility state index indicators, and the weight of each of the plurality of runtime facility state index indicators is indicated by a runtime state index weight indicator that corresponds to the runtime facility state index indicator.

In the present disclosure, the term “runtime facility state index indicator” refers to an indicator that represents, indicates, and/or comprises data and/or information associated with the operation and performance level associated with one aspect of the facility during runtime. In some embodiments, the runtime facility state index indicator may be in the form of text string(s), numerical character(s), alphabetical character(s), alphanumeric code(s), ASCII character(s), and/or the like.

Similar to those described above, examples of runtime facility state index indicators may be associated with different types. Example types of runtime facility state index indicators may include, but are not limited to, runtime alarm system performance index indicators, runtime field performance index indicators, runtime overall operation performance index indicators, runtime relative control performance index indicators, runtime safety performance index indicators, and/or the like.

In the present disclosure, the term “runtime state index weight indicator” refers to an indicator that represents, indicates, and/or comprises a weight associated with a corresponding runtime facility state index indicator for generating the runtime facility score indicator.

In some embodiments, a runtime state index weight indicator is assigned to the runtime alarm system performance index indicator, a runtime state index weight indicator is assigned to the runtime field performance index indicator, a runtime state index weight indicator is assigned to the runtime overall operation performance index indicator, a runtime state index weight indicator is assigned to the runtime relative control performance index indicator, and a runtime state index weight indicator is assigned to the runtime safety performance index indicator.

In some embodiments, the runtime state index weight indicator may be in the form of text string(s), numerical character(s), alphabetical character(s), alphanumeric code(s), ASCII character(s), and/or the like.

In the present disclosure, the term “facility steady state determination machine learning model” refers to a machine learning model that is trained to generate one or more steady state facility process variable indicators and/or one or more steady state derived process metric indicators as one or more outputs in response to receiving one or more historical/runtime facility process variable indicators and/or one or more historical/runtime derived process metric indicators as one or more inputs.

In the present disclosure, the term “steady state facility process variable indicator” refers to an indicator that represents, indicates, and/or comprises a steady state value associated with a plurality of facility process variable indicators. For example, a plurality of facility process variable indicators may be in the form of time series data that fluctuates over a time period, and the steady state facility process variable indicator indicates a value or a range of values associated with the facility process variable indicators when they reach the steady state. In some embodiments, the steady state facility process variable indicator may be in the form of text string(s), numerical character(s), alphabetical character(s), alphanumeric code(s), ASCII character(s), and/or the like.

For example, an example facility steady state determination machine learning model may comprise supervised machine learning algorithms. Examples of supervised machine learning algorithms may include, but are not limited to, classification models (such as, but not limited to, decision tree, random forest, and/or the like), regression models (such as, but not limited to, linear regression, logistic regression), and/or the like. In such an example, the facility steady state determination machine learning model may be trained under supervision by using one or more labeled datasets that comprise one or more historical/runtime facility process variable indicators and/or one or more historical/runtime derived process metric indicators and their corresponding known steady state facility process variable indicators and/or steady state derived process metric indicators. During supervised training, the example facility steady state determination machine learning model may receive historical/runtime facility process variable indicators and/or historical/runtime derived process metric indicators from the one or more labeled datasets as inputs, and may adjust one or more parameters of its machine learning algorithms such that the steady state facility process variable indicators and/or steady state derived process metric indicators from the example facility steady state determination machine learning model match the steady state facility process variable indicators and/or one or more steady state derived process metric indicators in the one or more labeled datasets.

As another example, an example facility steady state determination machine learning model may comprise unsupervised machine learning algorithms. Examples of unsupervised machine learning algorithms may include, but are not limited to, clustering models (such as, but not limited to, K-means clustering, hierarchical clustering, and/or the like), association models (such as, but not limited to, Apriori algorithm), and/or the like. In such an example, the facility steady state determination machine learning model may be trained by receiving one or more historical/runtime facility process variable indicators and/or one or more historical/runtime derived process metric indicators as an unlabeled dataset and identifying one or more patterns from the one or more historical/runtime facility process variable indicators and/or one or more historical/runtime derived process metric indicators to generate one or more steady state facility process variable indicators and/or one or more steady state derived process metric indicators as the outputs.

While the description above provides examples of facility steady state determination machine learning model, it is noted that the scope of the present disclosure is not limited to the description above. In some examples, an example facility steady state determination machine learning model may comprise one or more additional and/or alternative machine learning models. For example, an example facility steady state determination machine learning model may additionally or alternatively comprise support vector machine models, naive bayes models, artificial neural networks, and/or the like.

In the present disclosure, the term “runtime steady state facility process variable indicator” refers to a type of steady state facility process variable indicator that represents, indicates, and/or comprises a steady state value associated with a plurality of facility process variable indicators during runtime. In some embodiments, the runtime steady state facility process variable indicator may be in the form of text string(s), numerical character(s), alphabetical character(s), alphanumeric code(s), ASCII character(s), and/or the like.

In the present disclosure, the term “steady state derived process metric indicator” refers to an indicator that represents, indicates, and/or comprises a steady state value associated with a plurality of derived process metric indicators. For example, a plurality of derived process metric indicators may be in the form of time series data that fluctuates over a time period, and the steady state derived process metric indicator indicates a value or a range of values associated with the derived process metric indicators when they reach the steady state.

In some embodiments, the steady state derived process metric indicator may be in the form of text string(s), numerical character(s), alphabetical character(s), alphanumeric code(s), ASCII character(s), and/or the like.

In the present disclosure, the term “runtime steady state derived process metric indicator” refers to a type of steady state derived process metric indicator that represents, indicates, and/or comprises a steady state value associated with a plurality of derived process metric indicators during runtime.

In some embodiments, the runtime steady state derived process metric indicator may be in the form of text string(s), numerical character(s), alphabetical character(s), alphanumeric code(s), ASCII character(s), and/or the like.

In the present disclosure, the term “facility deterioration prediction machine learning model” refers to a machine learning model that is trained to generate one or more predicted facility deterioration indicators as one or more outputs in response to receiving one or more runtime facility state indicators, the runtime facility score indicators, and/or the facility state tree data object as inputs.

In the present disclosure, the term “predicted facility deterioration indicator” refers to an indicator that represents, indicates, and/or comprises data and/or information associated with a predicted likelihood that the performance of the facility will deteriorate. For example, the predicted facility deterioration indicator may indicate a predicted likelihood that the facility score indicator associated with the facility will decrease. In some embodiments, the predicted facility deterioration indicator may be in the form of text string(s), numerical character(s), alphabetical character(s), alphanumeric code(s), ASCII character(s), and/or the like.

For example, an example facility deterioration prediction machine learning model may comprise supervised machine learning algorithms. Examples of supervised machine learning algorithms may include, but are not limited to, classification models (such as, but not limited to, decision tree, random forest, and/or the like), regression models (such as, but not limited to, linear regression, logistic regression), and/or the like. In such an example, the facility deterioration prediction machine learning model may be trained under supervision by using one or more labeled datasets that comprise one or more runtime facility state indicators, one or more runtime facility score indicators, and/or the facility state tree data object and their corresponding known predicted facility deterioration indicators. During supervised training, the example facility deterioration prediction machine learning model may receive runtime facility state indicators, the runtime facility score indicators, and/or the facility state tree data object from the one or more labeled dataset as inputs, and may adjust one or more parameters of its machine learning algorithms such that the one or more predicted facility deterioration indicators from the example facility deterioration prediction machine learning model match the one or more predicted facility deterioration indicators in the one or more labeled datasets.

As another example, an example facility deterioration prediction machine learning model may comprise unsupervised machine learning algorithms. Examples of unsupervised machine learning algorithms may include, but are not limited to, clustering models (such as, but not limited to, K-means clustering, hierarchical clustering, and/or the like), association models (such as, but not limited to, Apriori algorithm), and/or the like. In such an example, the facility deterioration prediction machine learning model may be trained by receiving one or more runtime facility state indicators, one or more runtime facility score indicators, and/or the facility state tree data object as one or more unlabeled datasets and identifying one or more patterns from the one or more runtime facility state indicators, one or more runtime facility score indicators, and/or the facility state tree data object to generate one or more predicted facility deterioration indicators as the outputs.

While the description above provides examples of facility deterioration prediction machine learning model, it is noted that the scope of the present disclosure is not limited to the description above. In some examples, an example facility deterioration prediction machine learning model may comprise one or more additional and/or alternative machine learning models. For example, an example facility deterioration prediction machine learning model may additionally or alternatively comprise support vector machine models, naive bayes models, artificial neural networks, and/or the like.

In the present disclosure, the term “facility deterioration threshold indicator” refers to an indicator that represents, indicates, and/or comprises a threshold value associated with the predicted facility deterioration indicator. For example, if the predicted facility deterioration indicator does not satisfy the facility deterioration threshold indicator, the facility is predicted to be at a high risk of deteriorated performance. If the predicted facility deterioration indicator satisfies the facility deterioration threshold indicator, the facility is predicted to be at a low risk of deteriorated performance.

In some embodiments, the facility deterioration threshold indicator may be in the form of text string(s), numerical character(s), alphabetical character(s), alphanumeric code(s), ASCII character(s), and/or the like.

In the present disclosure, the term “facility deterioration alert indicator” refers to an indicator that represents, indicates, and/or comprises data and/or information associated with an alert or an alarm that the performance of the facility is at high risk of deterioration. In some embodiments, the facility deterioration alert indicator may be in the form of text string(s), numerical character(s), alphabetical character(s), alphanumeric code(s), ASCII character(s), and/or the like.

In the present disclosure, the term “remote operator assistance data object” refers to a type of data object that comprises data and/or information associated with one or more user actions associated with the facility. Additional details associated with generating the remote operator assistance data objects are described herein.

In the present disclosure, the term “historical remote operator action indicator” refers to an indicator that represents, indicates, and/or comprises data and/or information associated with an action that a user has taken in the past. In some embodiments, the historical remote operator action indicator may be in the form of text string(s), numerical character(s), alphabetical character(s), alphanumeric code(s), ASCII character(s), and/or the like.

In the present disclosure, the term “remote operator assistance data repository” refers to a database or a data repository that stores data and/or information associated with processes and/or operations of the facility. For example, the remote operator assistance data repository may store one or more facility state tree data objects associated with the facility.

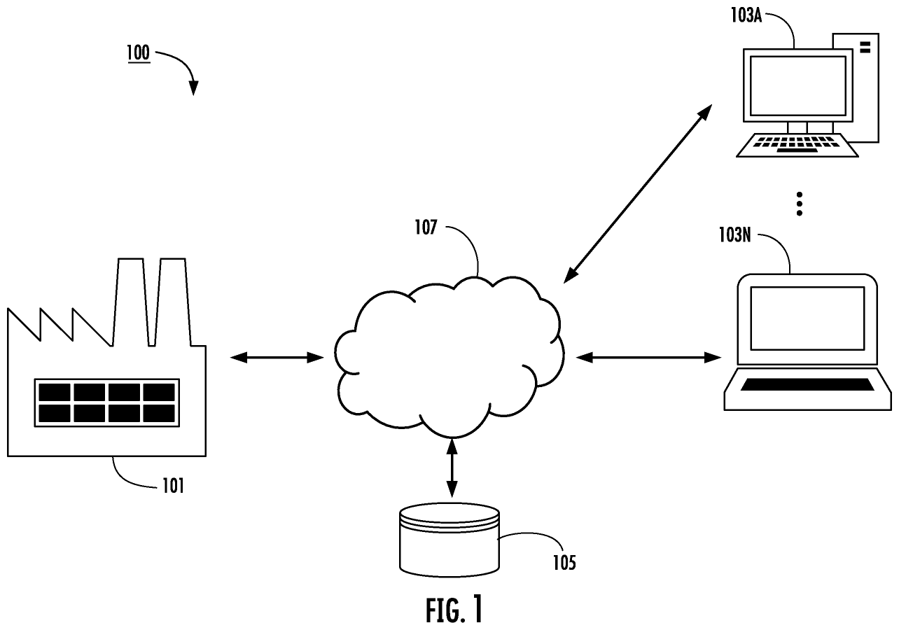

Referring now to FIG. 1, an example system architecture diagram illustrates an example integrated remote operation system 100 in accordance with some embodiments of the present disclosure. In the example shown in FIG. 1, the integrated remote operation system 100 comprises a facility 101, one or more integrated training and operator assistance computing devices (such as, but not limited to, the integrated training and operator assistance computing device 103A, . . . the integrated training and operator assistance computing device 103N), one or more data repository (such as, but not limited to, the remote operator assistance data repository 105).

In some embodiments, the facility 101 may be in the form of an operation facility such as, but not limited to, remote operation facility. Examples of operation facilities may include, but are not limited to, manufacturing plants, factories, production plants, and/or the like.

In some embodiments, the facility 101 may carry out one or more processes and operations (such as, but not limited to, one or more manufacturing processes/operations). In some embodiments, facility process variable indicators and derived process metric indicators are generated and transmitted to the one or more integrated training and operator assistance computing devices (such as, but not limited to, the integrated training and operator assistance computing device 103A, . . . the integrated training and operator assistance computing device 103N) through the communication network 107.

In one embodiment, the communication network 107 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the communication network 107 may have any suitable communication range associated therewith and may include, for example, global networks (e.g., the Internet), MANs, WANs, LANs, or PANs. In addition, the communication network 107 may include medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms/systems provided by network providers or other entities.

Further, the communication network 107 may utilize a variety of networking protocols including, but not limited to, TCP/IP based networking protocols. In some embodiments, the protocol is a custom protocol of JavaScript Object Notation (JSON) objects sent via a WebSocket channel. In some embodiments, the protocol is JSON over RPC, JSON over REST/HTTP, and/or the like.

In some embodiments, each of the one or more integrated training and operator assistance computing devices (such as, but not limited to, the integrated training and operator assistance computing device 103A, . . . the integrated training and operator assistance computing device 103N) may be in the form of a computing device (such as, but not limited to, one or more computers, computing entities, desktop computers, smart phones, tablets, phablets, notebooks, laptops, and/or the like). In some embodiments, the one or more integrated training and operator assistance computing devices (such as, but not limited to, the integrated training and operator assistance computing device 103A, . . . the integrated training and operator assistance computing device 103N) is in data communication with the remote operator assistance data repository 105, and may store data and/or information associated with the facility 101 in the remote operator assistance data repository 105 (such as, but not limited to, one or more facility state tree data objects associated with the facility 101).

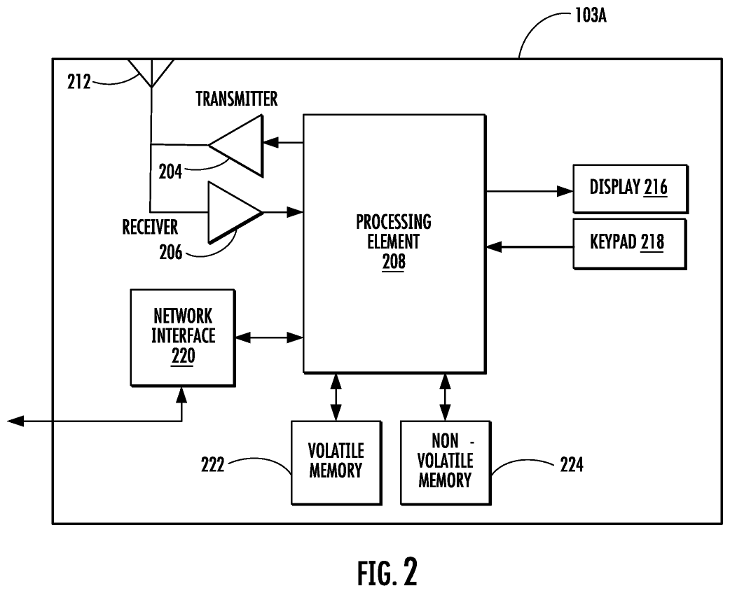

Referring now to FIG. 2, an example block diagram of an example integrated training and operator assistance computing device 103A in accordance with some embodiments of the present disclosure is illustrated.

For example, the example integrated training and operator assistance computing device 103A can include an antenna 212, a transmitter 204 (e.g., radio), a receiver 206 (e.g., radio), and a processing element 208 that provides signals to and receives signals from the transmitter 204 and receiver 206, respectively. The signals provided to and received from the transmitter 204 and the receiver 206, respectively, may include signaling information/data in accordance with an air interface standard of applicable wireless systems to communicate with various entities, such as a remote operator assistance data repository 105, another example integrated training and operator assistance computing device 103A, and/or the like. In this regard, the example integrated training and operator assistance computing device 103A may be capable of operating with one or more air interface standards, communication protocols, modulation types, and access types. More particularly, the example integrated training and operator assistance computing device 103A may comprise a network interface 220, and may operate in accordance with any of a number of wireless communication standards and protocols. In a particular embodiment, the example integrated training and operator assistance computing device 103A may operate in accordance with multiple wireless communication standards and protocols, such as GPRS, UMTS, CDMA1900, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the example integrated training and operator assistance computing device 103A can communicate with various other entities using Unstructured Supplementary Service data (USSD), Short Message Service (SMS), Multimedia Messaging Service (MMS), Dual-Tone Multi-Frequency (DTMF) Signaling, Subscriber Identity Module Dialer (SIM dialer), and/or the like. The example integrated training and operator assistance computing device 103A can also download changes, add-ons, and updates, for instance, to its firmware, software (e.g., including executable instructions, applications, program modules), and operating system.

According to one embodiment, the example integrated training and operator assistance computing device 103A may include location determining aspects, devices, modules, functionalities, and/or similar words used herein interchangeably. For example, the example integrated training and operator assistance computing device 103A may include outdoor positioning aspects, such as a location module adapted to acquire, for example, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information/data/data may be determined by triangulating the position in connection with a variety of other systems, including cellular towers, Wi-Fi access points, and/or the like. Similarly, the example integrated training and operator assistance computing device 103A may include indoor positioning aspects, such as a location module adapted to acquire, for example, latitude, longitude, altitude, geocode, course, direction, heading, speed, time, date, and/or various other information/data. Some of the indoor aspects may use various position or location technologies including Radio-Frequency Identification (RFID) tags, indoor beacons or transmitters, Wi-Fi access points, cellular towers, nearby computing devices (e.g., smartphones, laptops) and/or the like. For instance, such technologies may include iBeacons, Gimbal proximity beacons, Bluetooth Low Energy (BLE) transmitters, Near Field Communication (NFC) transmitters, and/or the like. These indoor positioning aspects can be used in a variety of settings to determine the location of someone or something to within inches or centimeters.

The example integrated training and operator assistance computing device 103A may also comprise a user interface comprising one or more user input/output interfaces (e.g., a display 216 and/or speaker/speaker driver coupled to a processing element 208 and a touch screen, keyboard, mouse, and/or microphone coupled to a processing element 208). For example, the user output interface may be configured to provide an application, browser, user interface, dashboard, webpage, and/or similar words used herein interchangeably executing on and/or accessible via the example integrated training and operator assistance computing device 103A to cause display or audible presentation of information/data and for user interaction therewith via one or more user input interfaces. The user output interface may be updated dynamically from communication with the remote operator assistance data repository 105. The user input interface can comprise any of a number of devices allowing the example integrated training and operator assistance computing device 103A to receive data, such as a keypad 218 (hard or soft), a touch display, voice/speech or motion interfaces, scanners, readers, or other input device. In embodiments including a keypad 218, the keypad 218 can include (or cause display of) the conventional numeric (0-9) and related keys (#, *), and other keys used for operating the example integrated training and operator assistance computing device 103A and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the example integrated training and operator assistance computing device 103A can collect information/data, user interaction/input, and/or the like.

The example integrated training and operator assistance computing device 103A can also include volatile storage or memory 222 and/or non-volatile storage or memory 224, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the operator assistance computing devices 103A-103N.

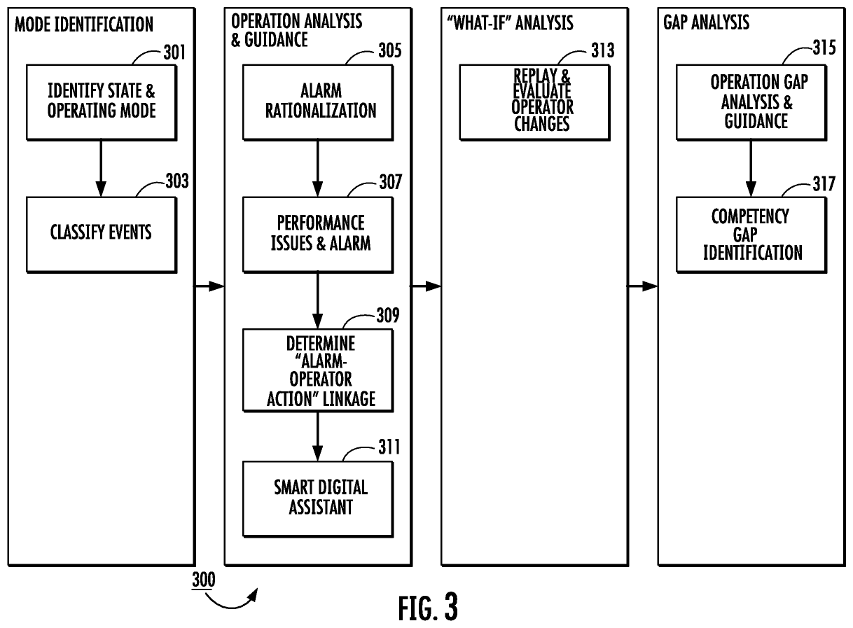

FIG. 3 illustrates an example machine learning model based integrated training and operator assistance method 300 that provides various technical improvements and advantages in accordance with some embodiments of the present disclosure. In the example shown in FIG. 3, the example method 300 comprises model identification steps/operations, operation analysis and guidance steps/operations, “what-if” analysis steps/operations, and gap analysis steps/operations.

In some embodiments, the model identification steps/operations comprise step/operation 301, where a computing device (such as, but not limited to, the example integrated training and operator assistance computing device described and illustrated above in connection with FIG. 1 and FIG. 2) may identify the state and operation mode of the facility.

For example, to enable the next level of improvement in plant performance, the computing device may predict lead indications of abnormal events (process stress) and the robustness of the process to deal with these (strength of protective and control systems), estimate future values of key performance indicators to enable corrective actions to be taken, assess on-job competency of the operator to enable training interventions, and provide real-time guidance to operators to ensure optimal operations. All the above steps/operations must have a component to estimate the plant state and operating mode because acceptable performance in one operation state/mode may not be acceptable in another operating state/mode. In some embodiments, the correct determination of plant state and operating mode will help to maximize the accuracy of the above solutions. In particular, current unit/asset performance monitoring and key performance indicators (KPI) do not contain readily consumable information to determine, identify the cause and diagnose plant state and operating mode.

In some embodiments, the model identification steps/operations comprise step/operation 303, where a computing device (such as, but not limited to, the example integrated training and operator assistance computing device described and illustrated above in connection with FIG. 1 and FIG. 2) may classify events.

For example, the computing device may provide data driven automatic labeling of rare events (i.e., large ratio of features to outcome) in multivariate data, train autonomous agents on the rare event data and use the trained autonomous agents to classify future events, and perform accurately even when the data may contain multiple overlapping events.

In some embodiments, the operation analysis and guidance steps/operations comprise step/operation 305, where a computing device (such as, but not limited to, the example integrated training and operator assistance computing device described and illustrated above in connection with FIG. 1 and FIG. 2) may perform alarm rationalization.

In particular, information provided by current alarm management systems is not complete for end users to perform detailed analysis to aid in identifying the root cause and help in resolution of the issue. As a result, end users must use their expertise. Alarm rationalizations enable faster root cause analysis by providing advanced features such as, but not limited to, identifying similarities between the different alarm floods, and analyzing whether the operator response was consistent for similar situations during the flood. In some embodiments, the computing device examines similarity across different floods by pattern searching for multiple alarm tags, consistency and effectiveness operator response in terms of the action taken, and time to respond by pattern searching for multiple events (such as alarms and actions) and integrating with documentation and enforcement (for checking the alarm response time as well as correctness of the response).

In some embodiments, the operation analysis and guidance steps/operations comprise step/operation 307, where a computing device (such as, but not limited to, the example integrated training and operator assistance computing device described and illustrated above in connection with FIG. 1 and FIG. 2) may identify performance issues and trigger alarm.

For example, the computing device may utilize related KPIs (performance, efficiencies, emissions) to process data including alarms so as to minimize lost opportunities to take corrective actions to maintain performance and safety when process issues are only recognized as they are occurring.

In some embodiments, the operation analysis and guidance steps/operations comprise step/operation 309, where a computing device (such as, but not limited to, the example integrated training and operator assistance computing device described and illustrated above in connection with FIG. 1 and FIG. 2) may determine “alarm-operator action” linkage.

For example, the operator guidelines or standard operating procedures may have such definitions of “alarm-operator action,” but these may not be up to date or may not be available in a compatible digital format. Applications such as alarm optimization systems and competency assessment systems may need to auto-identify “alarm-operator action” pairs from the information available within the DCS. In some embodiments, probabilistic models are used to derive the best operator response for an alarm resolution based on the relation between the device that went into the alarm mode and the devices that are operated for resolving the alarm.

In some embodiments, the operation analysis and guidance steps/operations comprise step/operation 311, where a computing device (such as, but not limited to, the example integrated training and operator assistance computing device described and illustrated above in connection with FIG. 1 and FIG. 2) may provide smart digital assistant.

While analyzing and identifying the cause of a plant upset or abnormal situation in an industrial plant, various embodiments of the present disclosure can assist an engineer to look at the problem holistically to enable identify causes and issues and consider asset/process relationships which may not previously be used/known. Instead of looking at a small slice of operation data, various embodiments of the present disclosure provide the operator and engineers a digital diary that enables them to consider contextually relevant plant state and history. For example, the digital diary will highlight knowledge related to the particular feed type or product grade (such as, but not limited to, polymer grade) being produced by the operations. As such, various embodiments of the present disclosure provide guidance to the operator based on most optimal previous situation, provide curated knowledge management (i.e., enable the operator to refer to the “best operator” response when resolving abnormal situations), and enable shared learnings in an embodiment that is cloud-enabled.

In some embodiments, the “what-if” analysis steps/operations comprise step/operation 313, where a computing device (such as, but not limited to, the example integrated training and operator assistance computing device described and illustrated above in connection with FIG. 1 and FIG. 2) may perform replay and evaluate operator changes.

For example, various embodiments of the present disclosure develops the “platinum operator” (for example, what the best operator could do if at their best all the time) and run an advanced mathematical representation of the process in parallel that keeps up with the current system state to ensure that the mathematical representation is always mirrored. As such, various embodiments of the present disclosure allow the operator to “try” actions and see the outcome before acting on the system, allow the operator to preview outcomes of actions on the process to enable operators to obtain answers to “what if I did this?,” allow the operator to explore potential actions without affecting the on-stream process, enable experiential learning and collaborating in real time to optimize process and cement the learning, and dispel the myth of “we always do it this way” by looking for better options.

In some embodiments, the gap analysis steps/operations comprise step/operation 315, where a computing device (such as, but not limited to, the example integrated training and operator assistance computing device described and illustrated above in connection with FIG. 1 and FIG. 2) may perform operation gap analysis and guidance.

For example, various embodiments of the present disclosure may identify the skill and knowledge gaps while operators, maintenance engineers, system engineers and field engineers in performing their tasks by analyzing the data recorded and accumulated in DCS, asset managers, change management systems and the records of configuration. In some embodiments, the analysis of these data and the access of the real-time process data can provide guidelines to operators to respond to the process alarms in an efficient and safe manner.

In some embodiments, the gap analysis steps/operations comprise step/operation 317, where a computing device (such as, but not limited to, the example integrated training and operator assistance computing device described and illustrated above in connection with FIG. 1 and FIG. 2) may perform competency gap identification.

For example, some operators may perform better than others at managing alarms. As such, consistency and uniformity can be a challenge. Alarms and change logs are available in the history of a plant, and the history data available in the DCS, or historian have the information of the process abnormalities and the operator actions performed in response to such process variable deviations. Analysis of this data using analytic techniques reveals the benchmark sequences of operator actions that need to be performed and the gaps in the operator performance to respond to process variable deviations. Gaps in operator performance can be filled with the appropriate guidance for an eventual better plant operation.

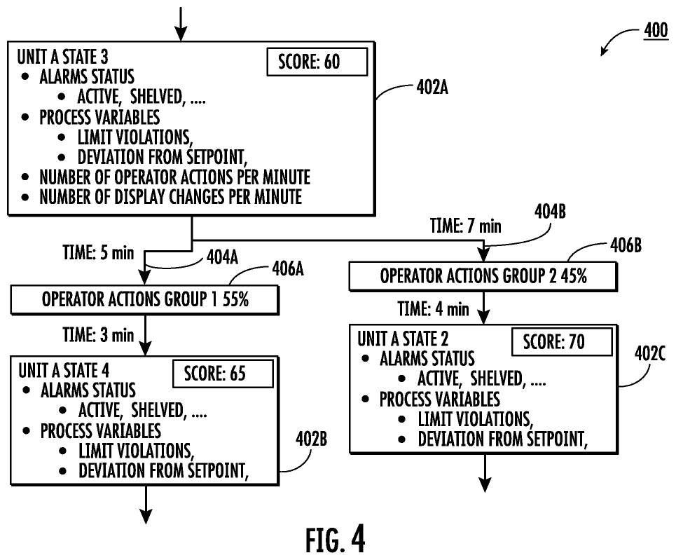

FIG. 4 illustrates an example facility state tree data object 400 in accordance with some embodiments of the present disclosure. In the example shown in FIG. 4, the facility state tree data object 400 comprises a plurality of facility state tree nodes and a plurality of facility state tree branches.

For example, the plurality of facility state tree nodes includes, but not limited to, the facility state tree node 402A, the facility state tree node 402B, and the facility state tree node 402C. The plurality of facility state tree branches includes, but not limited to, the facility state tree branch 404A and the facility state tree branch 404B. In the example shown in FIG. 4, the facility state tree branch 404A connects the facility state tree node 402A to the facility state tree node 402B, and the facility state tree branch 404B connects the facility state tree node 402A to the facility state tree node 402C.

In some embodiments, each of the plurality of facility state tree nodes (for example, but not limited to, the facility state tree node 402A, the facility state tree node 402B, and the facility state tree node 402C) is associated with a range of corresponding runtime steady state facility process variable indicators and/or a range of runtime steady state derived process metric indicators.

In some embodiments, each of the plurality of facility state tree branches (for example, but not limited to, the facility state tree branch 404A and the facility state tree branch 404B) is associated with a corresponding predicted facility state change likelihood indicator. For example, the facility state tree branch 404A is associated with the predicted facility state change likelihood indicator 406A indicating a 55% likelihood, and the facility state tree branch 404B is associated with the predicted facility state change likelihood indicator 406B indicating a 45% likelihood.

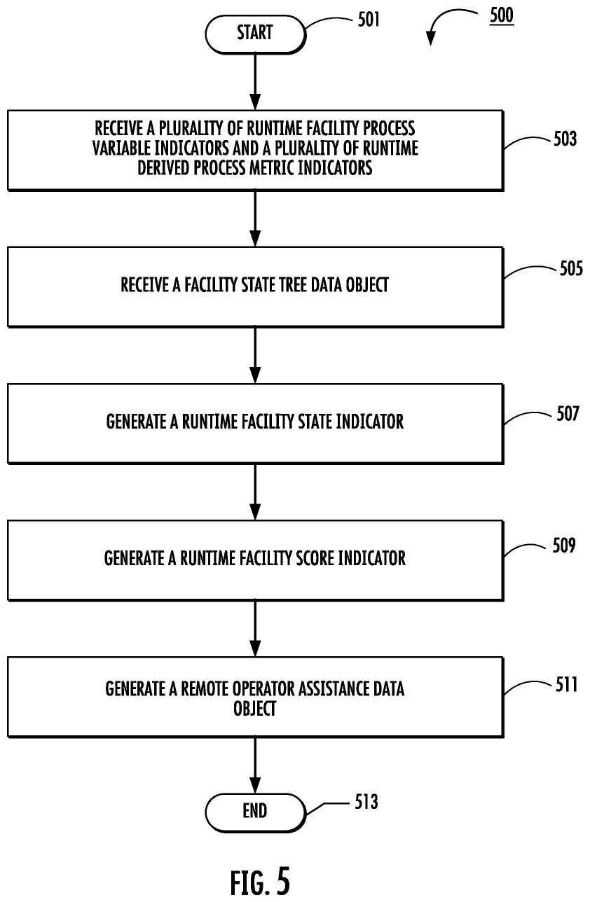

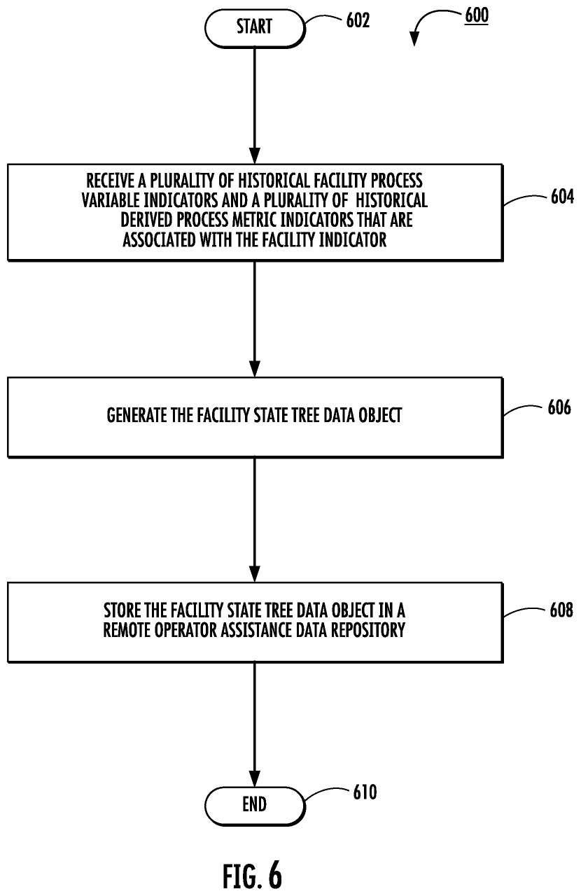

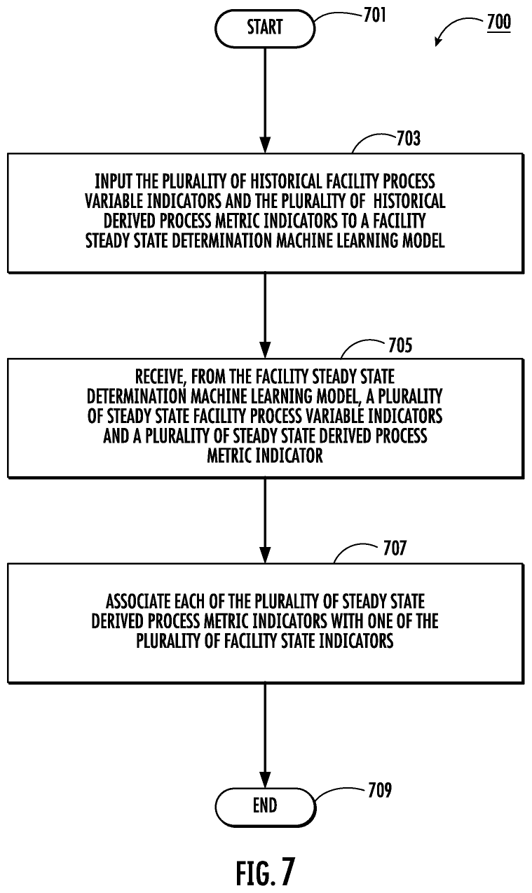

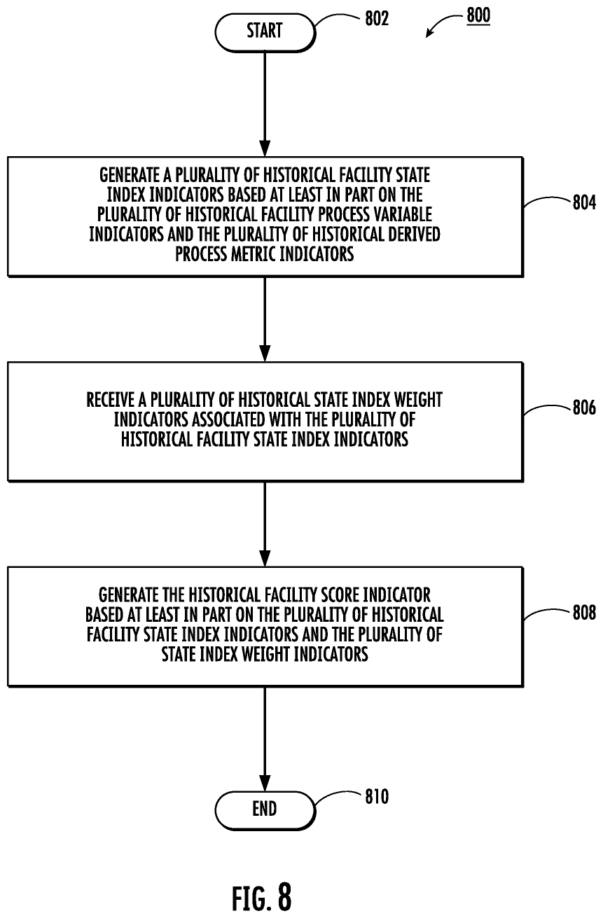

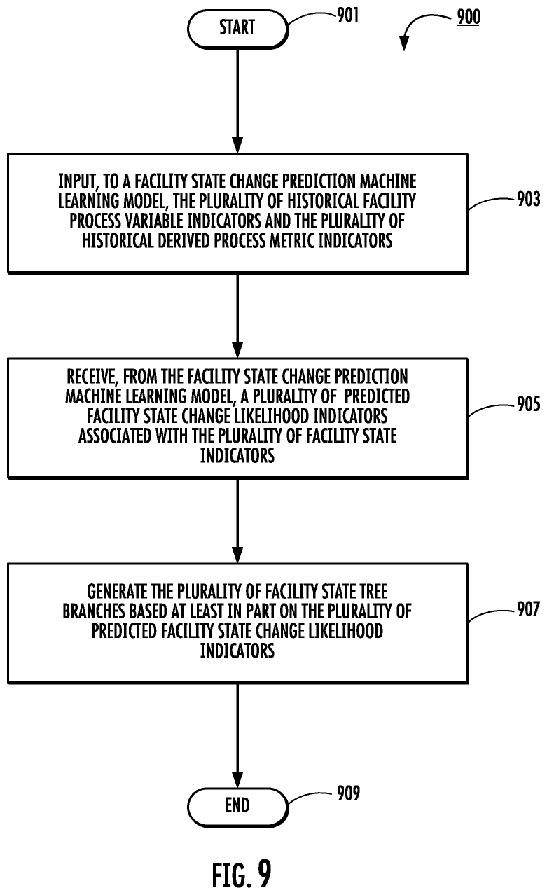

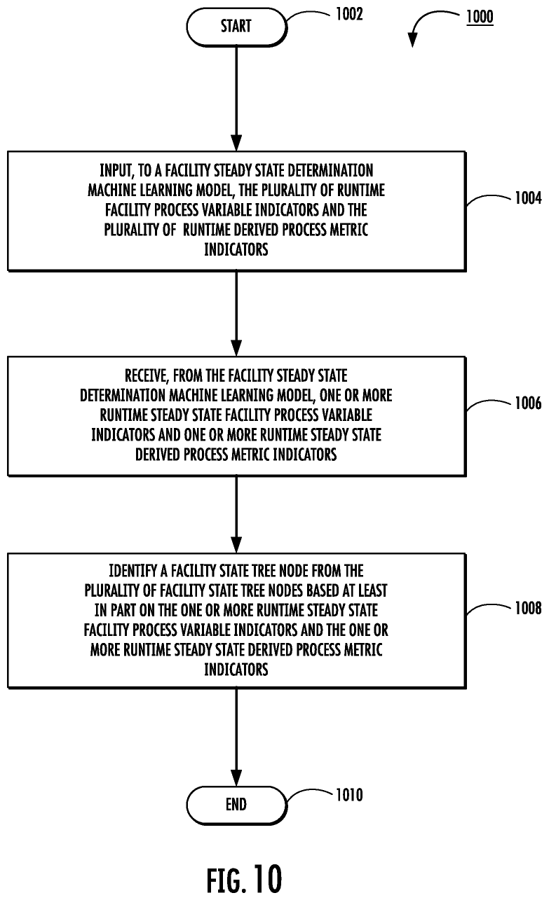

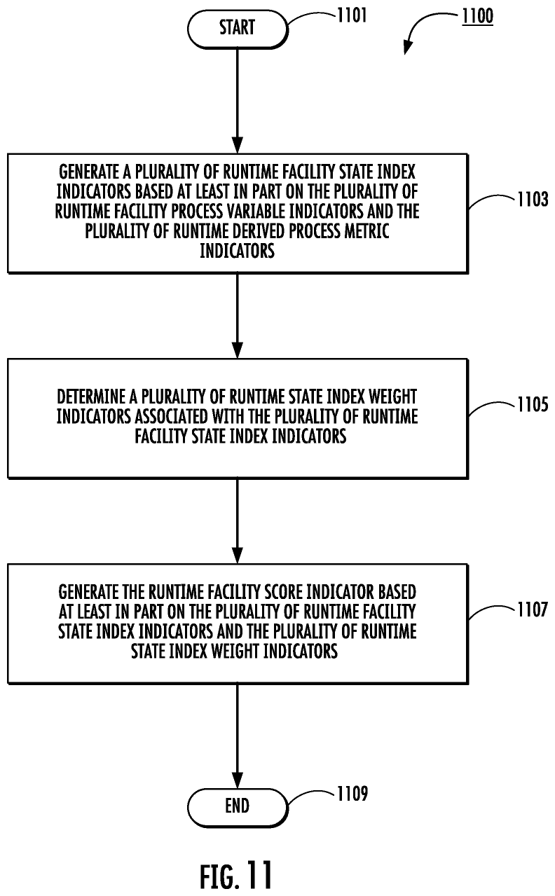

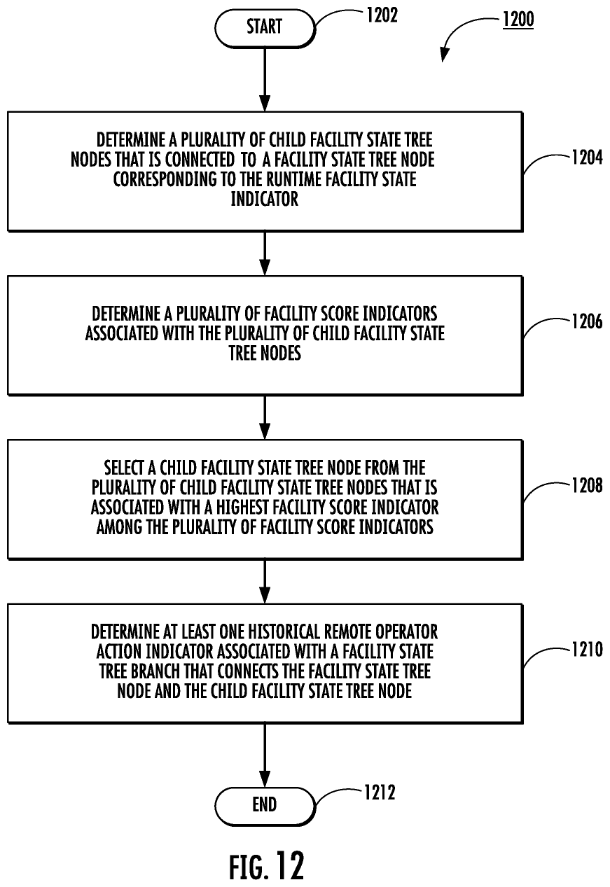

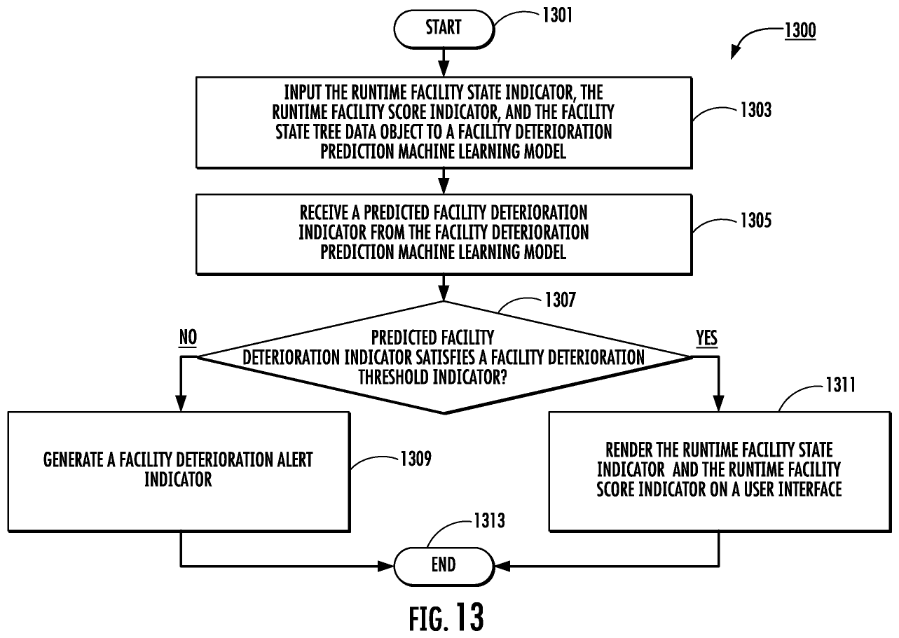

Reference will now be made to FIG. 5, FIG. 6, FIG. 7, FIG. 8, FIG. 9, FIG. 10, FIG. 11, FIG. 12, and FIG. 13, which provide flowcharts and diagrams illustrating example steps, processes, procedures, and/or operations associated with an example autonomous platform/system and/or an example integrated training and operator assistance computing device in accordance with various embodiments of the present disclosure.

Embodiments of the present disclosure may be implemented as computer program products that comprise articles of manufacture. Such computer program products may include one or more software components including, for example, applications, software objects, methods, data structures, and/or the like. A software component may be coded in any of a variety of programming languages. An illustrative programming language may be a lower-level programming language such as an assembly language associated with a particular hardware architecture and/or operating system platform/system. A software component comprising assembly language instructions may require conversion into executable machine code by an assembler prior to execution by the hardware architecture and/or platform/system. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Additionally, or alternatively, embodiments of the present disclosure may be implemented as a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media may include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatuses, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Referring now to FIG. 5, an example machine learning model based integrated training and operator assistance method 500 that provides various technical improvements and advantages in accordance with some embodiments of the present disclosure is illustrated.

In the example shown in FIG. 5, the example method 500 starts at step/operation 501. In some embodiments, subsequent to and/or response to step/operation 501, the example method 500 proceeds to step/operation 503. At step/operation 503, a computing device (such as, but not limited to, the example integrated training and operator assistance computing device described and illustrated above in connection with FIG. 1 and FIG. 2) may receive a plurality of runtime facility process variable indicators and a plurality of runtime derived process metric indicators.

In some embodiments, the plurality of runtime facility process variable indicators and the plurality of runtime derived process metric indicators are associated with a facility indicator.

For example, the runtime facility process variable indicators represent, indicate, and/or comprise data and/or information associated with one or more variables and/or parameters associated with one or more processes and/or operations in the facility associated with the facility indicator during runtime. In such an example, the runtime derived process metric indicators represent, indicate, and/or comprise data and/or information associated with one or more process metrics associated with the same facility during the same runtime.

In some embodiments, the facility indicator is associated with a plurality of facility unit indicators. In such an example, the plurality of runtime facility process variable indicators and the plurality of runtime derived process metric indicators are associated with at least one of the plurality of facility unit indicators.

For example, the runtime facility process variable indicators represent, indicate, and/or comprise data and/or information associated with one or more variables and/or parameters associated with one or more processes and/or operations of a unit associated with a facility unit indicator during runtime. In such an example, the runtime derived process metric indicators represent, indicate, and/or comprise data and/or information associated with one or more process metrics associated with the same unit of the facility during the same runtime.

Referring back to FIG. 5, subsequent to and/or response to step/operation 503, the example method 500 proceeds to step/operation 505. At step/operation 505, a computing device (such as, but not limited to, the example integrated training and operator assistance computing device described and illustrated above in connection with FIG. 1 and FIG. 2) may receive a facility state tree data object.

In some embodiments, the computing device may receive the facility state tree data object from a data repository (such as, but not limited to, the remote operator assistance data repository described above in connection with at least FIG. 1). In some embodiments, the facility state tree data object is associated with the same facility indicator as the facility indicator associated with the runtime facility process variable indicators and the runtime derived process metric indicators received at step/operation 503.

In some embodiments, the facility state tree data object comprises a plurality of facility state tree nodes. As described above, a facility state tree node refers to a data element of a facility state tree data object that corresponds to a facility state indicator. As such, the plurality of facility state tree nodes corresponds to a plurality of facility state indicators.

For example, the plurality of facility state indicators may comprise a facility normal state indicator, a facility low throughput state indicator, and a facility upset state indicator. In such an example, one or more facility state tree nodes of the facility state tree data object may represent or comprise facility normal state indicators, one or more facility state tree nodes of the facility state tree data object may represent or comprise facility low throughput state indicators, and/or one or more facility state tree nodes of the facility state tree data object may represent or comprise facility upset state indicators.

Referring back to FIG. 5, subsequent to and/or response to step/operation 505, the example method 500 proceeds to step/operation 507. At step/operation 507, a computing device (such as, but not limited to, the example integrated training and operator assistance computing device described and illustrated above in connection with FIG. 1 and FIG. 2) may generate a runtime facility state indicator.

In some embodiments, the computing device may generate the runtime facility state indicator based at least in part on the plurality of runtime facility process variable indicators receive at step/operation 503, the plurality of runtime derived process metric indicators received at step/operation 503, and the facility state tree data object received at step/operation 505.

For example, the computing device may determine one or more runtime steady state facility process variable indicators based on the plurality of runtime facility process variable indicators received at step/operation 503. As described above, each runtime steady state facility process variable indicator represents, indicates, and/or comprises a steady state value associated with the plurality of facility process variable indicators during runtime. In some embodiments, the computing device may determine the one or more runtime steady state facility process variable indicators by utilizing a facility steady state determination machine learning model.

Continuing in this example, the computing device may determine one or more runtime steady state derived process metric indicators based on the plurality of runtime derived process metric indicators received at step/operation 503. As described above, each runtime steady state derived process metric indicator represents, indicates, and/or comprises a steady state value associated with the plurality of derived process metric indicators during runtime. In some embodiments, the computing device may determine the one or more runtime steady state derived process metric indicators by utilizing a facility steady state determination machine learning model.

In some embodiments, based on the one or more runtime steady state facility process variable indicators and/or the one or more runtime steady state derived process metric indicators, the computing device may determine the corresponding facility state tree node from the facility state tree data object, and generate the runtime facility state indicator based on the corresponding facility state tree node.

Additional details associated with generating the runtime facility state indicator are described herein, including, but not limited to, those described in connection with at least FIG. 10.

Referring back to FIG. 5, subsequent to and/or response to step/operation 507, the example method 500 proceeds to step/operation 509. At step/operation 509, a computing device (such as, but not limited to, the example integrated training and operator assistance computing device described and illustrated above in connection with FIG. 1 and FIG. 2) may generate a runtime facility score indicator.

As described above, a runtime facility score indicator represents, indicates, and/or comprises a facility score that quantitatively indicates the overall operation and performance level associated with the facility during the runtime. In some embodiments, the computing device generates the runtime facility score indicator associated with the runtime facility state indicator based at least in part on the plurality of runtime facility process variable indicators and the plurality of runtime derived process metric indicators received at step/operations 503.

For example, based on the plurality of runtime facility process variable indicators and the plurality of runtime derived process metric indicators, the computing device may generate one or more runtime facility state index indicators. In some embodiments, based on the runtime facility state index indicators and a plurality of runtime state index weight indicators, the computing device may generate the runtime facility score indicator as a weight combination of the plurality of runtime facility state index indicators.

Referring back to FIG. 5, subsequent to and/or response to step/operation 509, the example method 500 proceeds to step/operation 511. At step/operation 511, a computing device (such as, but not limited to, the example integrated training and operator assistance computing device described and illustrated above in connection with FIG. 1 and FIG. 2) may generate a remote operator assistance data object.

In some embodiments, the computing device generates the remote operator assistance data object associated with the facility indicator based at least in part on the runtime facility state indicator generated at step/operation 507, the runtime facility score indicator generated at step/operation 509, and one or more machine learning models. For example, the computing device may input the runtime facility state indicator and the runtime facility score indicator to the one or more machine learning models to determine the likelihood of deterioration of the performance of the facility. If there is a high risk that the performance of the facility will deteriorate, the computing device generates the remote operator assistance data object that comprises a facility deterioration alert indicator. Additional details are described in connection with at least FIG. 13.

As described above, various embodiments of the present disclosure provide various technical improvements to various technologies and technological fields such as, but not limited to, the field of remote manufacturing. For example, by generating remote operator assistance data objects, various embodiments of the present disclosure reduce the likelihood of deteriorated performance and critical errors or failures in remote operation facilities.

Referring back to FIG. 5, subsequent to and/or response to step/operation 511, the example method 500 proceeds to step/operation 513 and ends.

Referring now to FIG. 6, an example machine learning model based integrated training and operator assistance method 600 that provides various technical improvements and advantages in accordance with some embodiments of the present disclosure is illustrated. In particular, the example method 600 may be performed to generate a facility state tree data object (for example, prior to receiving the facility state tree data object at step/operation 505 of FIG. 5).

In the example shown in FIG. 6, the example method 600 starts at step/operation 602. In some embodiments, subsequent to and/or response to step/operation 602, the example method 600 proceeds to step/operation 604. At step/operation 604, a computing device (such as, but not limited to, the example integrated training and operator assistance computing device described and illustrated above in connection with FIG. 1 and FIG. 2) may receive a plurality of historical facility process variable indicators and a plurality of historical derived process metric indicators that are associated with the facility indicator.

In some embodiments, the plurality of historical facility process variable indicators and the plurality of historical derived process metric indicators may be associated with the same facility indicator and/or the same facility unit indicator.

For example, the historical facility process variable indicators represent, indicate, and/or comprise data and/or information associated with one or more variables and/or parameters associated with one or more processes and/or operations in the facility associated with the facility indicator at a past time point or during a past time period. In such an example, the historical derived process metric indicators represent, indicate, and/or comprise data and/or information associated with one or more process metrics associated with the same facility during the same past time point or during the same past time period.

In some embodiments, the facility indicator is associated with a plurality of facility unit indicators. In such an example, the plurality of historical facility process variable indicators and the plurality of historical derived process metric indicators are associated with at least one of the plurality of facility unit indicators.

For example, the historical facility process variable indicators represent, indicate, and/or comprise data and/or information associated with one or more variables and/or parameters associated with one or more processes and/or operations of a unit associated with a facility unit indicator at a past time point or during a past time period. In such an example, the historical derived process metric indicators represent, indicate, and/or comprise data and/or information associated with one or more process metrics associated with the same unit of the facility at the same past time point or during the same past time period.

Referring back to FIG. 6, subsequent to and/or response to step/operation 604, the example method 600 proceeds to step/operation 606. At step/operation 606, a computing device (such as, but not limited to, the example integrated training and operator assistance computing device described and illustrated above in connection with FIG. 1 and FIG. 2) may generate the facility state tree data object.

In some embodiments, the computing device generates a facility state tree data object associated with the facility indicator (or the facility unit indicator) based at least in part on the plurality of historical facility process variable indicators and the plurality of historical derived process metric indicators received at step/operation 604.

As described above, the facility state tree data object may comprise a plurality of facility state tree nodes and a plurality of facility state tree branches. In some embodiments, the plurality of facility state tree branches connects the plurality of facility state tree nodes.

In some embodiments, the computing device generates the plurality of facility state tree nodes based at least in part on a plurality of steady state facility process variable indicators and a plurality of steady state derived process metric indicators that are generated based on the plurality of historical facility process variable indicators and the plurality of historical derived process metric indicators. For example, the computing device may generate a facility state tree node for each of the plurality of steady state derived process metric indicators, and associate the facility state tree node with one of the plurality of facility state indicators. Additional details associated with generating the facility state tree nodes are described herein, including, but not limited to, those described in connection with at least FIG. 7 and FIG. 8.

In some embodiments, the computing device generates the plurality of facility state tree branches to represent the transitions from one facility state indicator to another facility state indicator. In some embodiments, the plurality of facility state tree branches may represent the likelihood of transition from one facility state indicator to another facility state indicator. Additional details associated with generating the plurality of facility state tree branches are described herein, including, but not limited to, those described in connection with FIG. 9.

As described above, various embodiments of the present disclosure provide various technical improvements to various technologies and technological fields such as, but not limited to, the field of remote manufacturing. For example, by generating facility state tree data objects, various embodiments may improve the accuracy of characterizing and predicting the further state of the remote operation facilities while reducing the likelihood of deteriorated performance and critical errors or failures in remote operation facilities.

Referring back to FIG. 6, subsequent to and/or response to step/operation 606, the example method 600 proceeds to step/operation 608. At step/operation 608, a computing device (such as, but not limited to, the example integrated training and operator assistance computing device described and illustrated above in connection with FIG. 1 and FIG. 2) may store the facility state tree data object in a remote operator assistance data repository.

Referring back to FIG. 6, subsequent to and/or response to step/operation 608, the example method 600 proceeds to step/operation 610 and ends.

Referring now to FIG. 7, an example machine learning model based integrated training and operator assistance method 700 that provides various technical improvements and advantages in accordance with some embodiments of the present disclosure is illustrated. In particular, the example method 700 illustrates example processes and/or operations associated with generating the facility state tree data object.

In the example shown in FIG. 7, the example method 700 starts at step/operation 701. In some embodiments, subsequent to and/or response to step/operation 701, the example method 700 proceeds to step/operation 703. At step/operation 703, a computing device (such as, but not limited to, the example integrated training and operator assistance computing device described and illustrated above in connection with FIG. 1 and FIG. 2) may input the plurality of historical facility process variable indicators and the plurality of historical derived process metric indicators to a facility steady state determination machine learning model.

For example, the computing device may receive the plurality of historical facility process variable indicators and the plurality of historical derived process metric indicators in a way similar to those described in connection with step/operation 604 above.

As described above, the facility steady state determination machine learning model comprises a machine learning model that is trained to generate one or more steady state facility process variable indicators and/or one or more steady state derived process metric indicators as one or more outputs in response to receiving one or more historical facility process variable indicators and/or one or more historical derived process metric indicators as one or more inputs.

For example, the facility steady state determination machine learning model may be trained based at least in part on Kullback-Leibler divergence calculation, which represents statistical distances to measure how one probability distribution Q is different from a second, reference probability distribution. Additionally, or alternatively, the facility steady state determination machine learning model may be trained through other mechanisms.

As described above, various embodiments of the present disclosure provide various technical improvements to various technologies and technological fields such as, but not limited to, the field of remote manufacturing. For example, by implementing facility steady state determination machine learning model, various embodiments may improve the accuracy of determining the steady state of the remote operation facilities.

Referring back to FIG. 7, subsequent to and/or response to step/operation 703, the example method 700 proceeds to step/operation 705. At step/operation 705, a computing device (such as, but not limited to, the example integrated training and operator assistance computing device described and illustrated above in connection with FIG. 1 and FIG. 2) may receive, from the facility steady state determination machine learning model, a plurality of steady state facility process variable indicators and a plurality of steady state derived process metric indicator.

As described above, both the plurality of historical facility process variable indicators and the plurality of historical derived process metric indicators may comprise time series values that may fluctuate over a time period. In such an example, each of the steady state facility process variable indicator represents, indicates, and/or comprises a steady state value associated with the plurality of historical facility process variable indicators, and each of the steady state derived process metric indicator represents, indicates, and/or comprises a steady state value associated with the plurality of historical derived process metric indicators.

Referring back to FIG. 7, subsequent to and/or response to step/operation 705, the example method 700 proceeds to step/operation 707. At step/operation 707, a computing device (such as, but not limited to, the example integrated training and operator assistance computing device described and illustrated above in connection with FIG. 1 and FIG. 2) may associate each of the plurality of steady state derived process metric indicators with one of the plurality of facility state indicators.

In some embodiments, the computing device associates each of the plurality of steady state derived process metric indicators with one of the plurality of facility state indicators.

For example, each of the plurality of facility state indicators may provide a range of steady state derived process metric indicators that is associated with the corresponding facility state. In some embodiments, the computing device determines the facility state indicator that corresponds to a steady state derived process metric indicator received at step/operation 806, and generates a corresponding facility state tree node.

Referring back to FIG. 7, subsequent to and/or response to step/operation 707, the example method 700 proceeds to step/operation 709 and ends.

Referring now to FIG. 8, an example machine learning model based integrated training and operator assistance method 800 that provides various technical improvements and advantages in accordance with some embodiments of the present disclosure is illustrated.

In some embodiments, the plurality of facility state tree nodes comprises a plurality of historical facility score indicators that indicates a historical facility score associated with each facility state tree node. In such examples, the example method 800 provides an example mechanism for generating the historical facility score indicator for each facility state tree node based at least in part on the plurality of historical facility process variable indicators and the plurality of historical derived process metric indicators.

In the example shown in FIG. 8, the example method 800 starts at step/operation 802. In some embodiments, subsequent to and/or response to step/operation 802, the example method 800 proceeds to step/operation 804. At step/operation 804, a computing device (such as, but not limited to, the example integrated training and operator assistance computing device described and illustrated above in connection with FIG. 1 and FIG. 2) may generate a plurality of historical facility state index indicators based at least in part on the plurality of historical facility process variable indicators and the plurality of historical derived process metric indicators.

In some embodiments, the computing device may receive a plurality of historical facility process variable indicators and the plurality of historical derived process metric indicators, similar to those described above in connection with at least step/operation 604 of FIG. 6 and/or step/operation 703 of FIG. 7. In some embodiments, the computing device generates the plurality of historical facility state index indicators based at least in part on the plurality of historical facility process variable indicators and the plurality of historical derived process metric indicators.

As described above, the historical derived process metric indicators may comprise data and/or information that determines which historical derived process metric indicator(s) to analyze in determining the process metric associated with the facility, as well as the priority in analyzing the historical derived process metric indicator(s). In some embodiments, the historical derived process metric indicators may positively or negatively affect one or more of historical facility state index indicators.

In some embodiments, the plurality of historical facility state index indicators comprises a historical alarm system performance index indicator, a historical overall operation performance index indicator, a historical field performance index indicator, a historical relative control performance index indicator, and a historical safety performance index indicator. In some embodiments, the plurality of historical facility state index indicators may comprise one or more additional and/or alternative historical facility state index indicators.

Referring back to FIG. 8, subsequent to and/or response to step/operation 804, the example method 800 proceeds to step/operation 806. At step/operation 806, a computing device (such as, but not limited to, the example integrated training and operator assistance computing device described and illustrated above in connection with FIG. 1 and FIG. 2) may receive a plurality of historical state index weight indicators associated with the plurality of historical facility state index indicators.

As described above, the plurality of historical state index weight indicators represents, indicates, and/or comprises a weight associated with a corresponding historical facility state index indicator for generating the historical facility score indicator.

Referring back to FIG. 8, subsequent to and/or response to step/operation 806, the example method 800 proceeds to step/operation 808. At step/operation 808, a computing device (such as, but not limited to, the example integrated training and operator assistance computing device described and illustrated above in connection with FIG. 1 and FIG. 2) may generate the historical facility score indicator based at least in part on the plurality of historical facility state index indicators and the plurality of historical state index weight indicators.

In some embodiments, the historical facility score indicator is a weighted combination of the plurality of historical facility state index indicators based on the plurality of historical state index weight indicators as described above.

Referring back to FIG. 8, subsequent to and/or response to step/operation 808, the example method 800 proceeds to step/operation 810 and ends.

Referring now to FIG. 9, an example machine learning model based integrated training and operator assistance method 900 that provides various technical improvements and advantages in accordance with some embodiments of the present disclosure is illustrated. As described above, the facility state tree data object comprises a plurality of facility state tree branches connecting the plurality of facility state tree nodes. The example method 900 illustrates an example mechanism for generating the facility state tree branches.

In the example shown in FIG. 9, the example method 900 starts at step/operation 901. In some embodiments, subsequent to and/or response to step/operation 901, the example method 900 proceeds to step/operation 903. At step/operation 903, a computing device (such as, but not limited to, the example integrated training and operator assistance computing device described and illustrated above in connection with FIG. 1 and FIG. 2) may input, to a facility state change prediction machine learning model, the plurality of historical facility process variable indicators and the plurality of historical derived process metric indicators.

As described above, the facility state change prediction machine learning model comprises a machine learning model that is trained to generate one or more predicted facility state change likelihood indicators as one or more outputs in response to receiving one or more historical facility process variable indicators and one or more historical derived process metric indicators as inputs.

In some embodiments, the plurality of historical facility process variable indicators and the plurality of historical derived process metric indicators are associated with the same past time point and/or past time period.

As described above, various embodiments of the present disclosure provide various technical improvements to various technologies and technological fields such as, but not limited to, the field of remote manufacturing. For example, by implementing the facility state change prediction machine learning model, various embodiments may improve the accuracy of predicting facility state change in remote operation facilities.

Referring back to FIG. 9, subsequent to and/or response to step/operation 903, the example method 900 proceeds to step/operation 905. At step/operation 905, a computing device (such as, but not limited to, the example integrated training and operator assistance computing device described and illustrated above in connection with FIG. 1 and FIG. 2) may receive, from the facility state change prediction machine learning model, a plurality of predicted facility state change likelihood indicators associated with the plurality of facility state indicators.

As described above, the predicted facility state change likelihood indicator represents, indicates, and/or comprises the likelihood that the facility transitions from one facility state to another facility state at a given time point or during a given time period.

Referring back to FIG. 9, subsequent to and/or response to step/operation 905, the example method 900 proceeds to step/operation 907. At step/operation 907, a computing device (such as, but not limited to, the example integrated training and operator assistance computing device described and illustrated above in connection with FIG. 1 and FIG. 2) may generate the plurality of facility state tree branches based at least in part on the plurality of predicted facility state change likelihood indicators.

As described above, an example facility state tree branch indicates a transition from one facility state to another facility state. In such an example, the computing device may generate the facility state tree branch to represent the likelihood of the transition from one facility state to another facility state based on the predicted facility state change likelihood indicator received at step/operation 905.

Referring back to FIG. 9, subsequent to and/or response to step/operation 907, the example method 900 proceeds to step/operation 909 and ends.

Referring now to FIG. 10, an example machine learning model based integrated training and operator assistance method 1000 that provides various technical improvements and advantages in accordance with some embodiments of the present disclosure is illustrated. In particular, the example method 1000 illustrates example processes and/or operations associated with generating a runtime facility state indicator.

In the example shown in FIG. 10, the example method 1000 starts at step/operation 1002. In some embodiments, subsequent to and/or response to step/operation 1002, the example method 1000 proceeds to step/operation 1004. At step/operation 1004, a computing device (such as, but not limited to, the example integrated training and operator assistance computing device described and illustrated above in connection with FIG. 1 and FIG. 2) may input, to a facility steady state determination machine learning model, the plurality of runtime facility process variable indicators and the plurality of runtime derived process metric indicators.

As described above, the facility steady state determination machine learning model comprises a machine learning model that is trained to generate one or more steady state facility process variable indicators and/or one or more steady state derived process metric indicators as one or more outputs in response to receiving one or more runtime facility process variable indicators and/or one or more runtime derived process metric indicators as one or more inputs.

As described above, various embodiments of the present disclosure provide various technical improvements to various technologies and technological fields such as, but not limited to, the field of remote manufacturing. For example, by implementing facility steady state determination machine learning model, various embodiments may improve the accuracy of determining the steady state of the remote operation facilities.

Referring back to FIG. 10, subsequent to and/or response to step/operation 1004, the example method 1000 proceeds to step/operation 1006. At step/operation 1006, a computing device (such as, but not limited to, the example integrated training and operator assistance computing device described and illustrated above in connection with FIG. 1 and FIG. 2) may receive, from the facility steady state determination machine learning model, one or more runtime steady state facility process variable indicators and one or more runtime steady state derived process metric indicators.

As described above, each runtime steady state facility process variable indicator represents, indicates, and/or comprises a steady state value associated with a plurality of facility process variable indicators during runtime, and each runtime steady state derived process metric indicator comprises a steady state value associated with a plurality of derived process metric indicators during runtime.

Referring back to FIG. 10, subsequent to and/or response to step/operation 1006, the example method 1000 proceeds to step/operation 1008. At step/operation 1008, a computing device (such as, but not limited to, the example integrated training and operator assistance computing device described and illustrated above in connection with FIG. 1 and FIG. 2) may identify a facility state tree node from the plurality of facility state tree nodes based at least in part on the one or more runtime steady state facility process variable indicators and the one or more runtime steady state derived process metric indicators.

As described above, the facility state tree data object comprises a plurality of facility state tree nodes, and each of the plurality of facility state tree nodes is associated with a range of corresponding runtime steady state facility process variable indicators and/or a range of runtime steady state derived process metric indicators. In such an example, the computing selects the facility state tree node from the plurality of facility state tree nodes based on determining which range of the runtime steady state facility process variable indicators that the runtime steady state facility process variable indicator received at step/operation 1006 falls into, and/or which range of the runtime steady state derived process metric indicators that the runtime steady state derived process metric indicator received at step/operation 1006 falls into.

Referring back to FIG. 10, subsequent to and/or response to step/operation 1008, the example method 1000 proceeds to step/operation 1010 and ends.

Referring now to FIG. 11, an example machine learning model based integrated training and operator assistance method 1100 that provides various technical improvements and advantages in accordance with some embodiments of the present disclosure is illustrated. In particular, FIG. 11 illustrates example processes and/or operations associated with generating the runtime facility score indicator.

In the example shown in FIG. 11, the example method 1100 starts at step/operation 1101. In some embodiments, subsequent to and/or response to step/operation 1101, the example method 1100 proceeds to step/operation 1103. At step/operation 1103, a computing device (such as, but not limited to, the example integrated training and operator assistance computing device described and illustrated above in connection with FIG. 1 and FIG. 2) may generate a plurality of runtime facility state index indicators based at least in part on the plurality of runtime facility process variable indicators and the plurality of runtime derived process metric indicators.

In some embodiments, the computing device may receive a plurality of runtime facility process variable indicators and the plurality of runtime derived process metric indicators, similar to those described above in connection with at least step/operation 604 of FIG. 6 and/or step/operation 703 of FIG. 7. In some embodiments, the computing device generates the plurality of runtime facility state index indicators based at least in part on the plurality of runtime facility process variable indicators and the plurality of runtime derived process metric indicators.

As described above, the runtime derived process metric indicators may comprise data and/or information that determines which runtime derived process metric indicator(s) to analyze in determining the process metric associated with the facility, as well as the priority in analyzing the runtime derived process metric indicator(s). In some embodiments, the runtime derived process metric indicators may positively or negatively affect one or more of runtime facility state index indicators.

In some embodiments, the plurality of runtime facility state index indicators comprises a runtime alarm system performance index indicator, a runtime overall operation performance index indicator, a runtime field performance index indicator, a runtime relative control performance index indicator, and a runtime safety performance index indicator. In some embodiments, the plurality of runtime facility state index indicators may comprise one or more additional and/or alternative runtime facility state index indicators.

Referring back to FIG. 11, subsequent to and/or response to step/operation 1103, the example method 1100 proceeds to step/operation 1105. At step/operation 1105, a computing device (such as, but not limited to, the example integrated training and operator assistance computing device described and illustrated above in connection with FIG. 1 and FIG. 2) may determine a plurality of runtime state index weight indicators associated with the plurality of runtime facility state index indicators.

As described above, the plurality of runtime state index weight indicators represents, indicates, and/or comprises a weight associated with a corresponding runtime facility state index indicator for generating the runtime facility score indicator.

Referring back to FIG. 11, subsequent to and/or response to step/operation 1105, the example method 1100 proceeds to step/operation 1107. At step/operation 1107, a computing device (such as, but not limited to, the example integrated training and operator assistance computing device described and illustrated above in connection with FIG. 1 and FIG. 2) may generate the runtime facility score indicator based at least in part on the plurality of runtime facility state index indicators and the plurality of runtime state index weight indicators.

In some embodiments, the runtime facility score indicator is a weighted combination of the plurality of runtime facility state index indicators based on the plurality of runtime state index weight indicators as described above.

Referring back to FIG. 11, subsequent to and/or response to step/operation 1107, the example method 1100 proceeds to step/operation 1109 and ends.

Referring now to FIG. 12, an example machine learning model based integrated training and operator assistance method 1200 that provides various technical improvements and advantages in accordance with some embodiments of the present disclosure is illustrated.

In some embodiments, the facility state tree data object comprises a plurality of facility state tree branches connecting the plurality of facility state tree nodes. In some embodiments, the plurality of facility state tree branches is associated with a plurality of historical remote operator action indicators. As such, the example method 1200 illustrates example processes and/or operations associated with generating the remote operator assistance data object based on the historical remote operator action indicators.

In the example shown in FIG. 12, the example method 1200 starts at step/operation 1202. In some embodiments, subsequent to and/or response to step/operation 1202, the example method 1200 proceeds to step/operation 1204. At step/operation 1204, a computing device (such as, but not limited to, the example integrated training and operator assistance computing device described and illustrated above in connection with FIG. 1 and FIG. 2) may determine a plurality of child facility state tree nodes that is connected to a facility state tree node corresponding to the runtime facility state indicator.

As described above, each of the facility state tree nodes may be connected to a plurality of child facility state tree nodes through a plurality of facility state tree branches. In some embodiments, the computing device determines a runtime facility state indicator that represents the current facility state (for example, based on the various example methods described herein), may determine a facility state tree node that corresponds to the runtime facility state indicator, and may determine a plurality of child facility state tree nodes that is connected to the facility state tree node.

Referring back to FIG. 12, subsequent to and/or response to step/operation 1204, the example method 1200 proceeds to step/operation 1206. At step/operation 1206, a computing device (such as, but not limited to, the example integrated training and operator assistance computing device described and illustrated above in connection with FIG. 1 and FIG. 2) may determine a plurality of facility score indicators associated with the plurality of child facility state tree nodes.

As described above, each facility state tree node is associated with a facility score indicator. In such an example, the facility score indicator provides a facility score that quantitatively indicates the overall operation and performance level associated with the current state of the facility.

In some embodiments, each child facility state tree node represents a possible future facility state associated with the facility, and the computer device determines the plurality of facility score indicators associated with the plurality of child facility state tree nodes that represents the future operation and performance levels associated with the facility.

Referring back to FIG. 12, subsequent to and/or response to step/operation 1206, the example method 1200 proceeds to step/operation 1208. At step/operation 1208, a computing device (such as, but not limited to, the example integrated training and operator assistance computing device described and illustrated above in connection with FIG. 1 and FIG. 2) may select a child facility state tree node from the plurality of child facility state tree nodes that is associated with a highest facility score indicator among the plurality of facility score indicators.

As described above, the higher the facility score, the better the performance associated with the facility, and the more desirable to operate in the facility. As such, the computing device selects a future operation state associated with the facility that has the best performance associated with the facility.

Referring back to FIG. 12, subsequent to and/or response to step/operation 1208, the example method 1200 proceeds to step/operation 1210. At step/operation 1210, a computing device (such as, but not limited to, the example integrated training and operator assistance computing device described and illustrated above in connection with FIG. 1 and FIG. 2) may determine at least one historical remote operator action indicator associated with a facility state tree branch that connects the facility state tree node and the child facility state tree node.

In some embodiments, the computing device determines at least one historical remote operator action indicator associated with a facility state tree branch that connects the facility state tree node and the child facility state tree node selected at step/operation 1208. In such an example, the at least one historical remote operator action indicator represents, indicates, and/or comprises one or more actions that were taken by the remote operator to cause the facility to transition from the current state to the desirable state.

In some embodiments, the computing device generates the remote operator assistance data object based at least in part on the at least one historical remote operator action indicator. In other words, the computing device generates the remote operator assistance data object that comprises data and/or information associated with the one or more actions that were taken by the remote operator to cause the facility to transition from the current state to the desirable state.

Referring back to FIG. 12, subsequent to and/or response to step/operation 1210, the example method 1200 proceeds to step/operation 1212 and ends.

Referring now to FIG. 13, an example machine learning model based integrated training and operator assistance method 1300 that provides various technical improvements and advantages in accordance with some embodiments of the present disclosure is illustrated. In particular, the example method 1300 illustrates example processes and operations associated with generating the remote operator assistance data object associated with the facility indicator.

In the example shown in FIG. 13, the example method 1300 starts at step/operation 1301. In some embodiments, subsequent to and/or response to step/operation 1301, the example method 1300 proceeds to step/operation 1303. At step/operation 1303, a computing device (such as, but not limited to, the example integrated training and operator assistance computing device described and illustrated above in connection with FIG. 1 and FIG. 2) may input the runtime facility state indicator, the runtime facility score indicator, and the facility state tree data object to a facility deterioration prediction machine learning model.

As described above, the facility deterioration prediction machine learning model comprises a machine learning model that is trained to generate one or more predicted facility deterioration indicators as one or more outputs in response to receiving one or more runtime facility state indicators, the runtime facility score indicators, and/or the facility state tree data object as inputs. For example, the facility deterioration prediction machine learning model may be trained to analyze the runtime facility state indicator and/or the runtime facility score indicator based on the facility state tree data object to determine the likelihood that the performance level of the facility may deteriorate in the future.

As described above, various embodiments of the present disclosure provide various technical improvements to various technologies and technological fields such as, but not limited to, the field of remote manufacturing. For example, by implementing the facility deterioration prediction machine learning model, various embodiments may improve the accuracy in predicting deterioration in remote operation facilities.

Referring back to FIG. 13, subsequent to and/or response to step/operation 1303, the example method 1300 proceeds to step/operation 1305. At step/operation 1305, a computing device (such as, but not limited to, the example integrated training and operator assistance computing device described and illustrated above in connection with FIG. 1 and FIG. 2) may receive a predicted facility deterioration indicator from the facility deterioration prediction machine learning model.

As described above, the predicted facility deterioration indicator represents, indicates, and/or comprises data and/or information associated with a predicted likelihood that the performance of the facility will deteriorate.

Referring back to FIG. 13, subsequent to and/or response to step/operation 1305, the example method 1300 proceeds to step/operation 1307. At step/operation 1307, a computing device (such as, but not limited to, the example integrated training and operator assistance computing device described and illustrated above in connection with FIG. 1 and FIG. 2) may determine whether the predicted facility deterioration indicator satisfies a facility deterioration threshold indicator.

As described above, the predicted facility deterioration indicator represents, indicates, and/or comprises a threshold value associated with the predicted facility deterioration indicator.

If, at step/operation 1307, the computing device determines that the predicted facility deterioration indicator does not satisfy the facility deterioration threshold indicator, the example method 1300 proceeds to step/operation 1309. At step/operation 1309, a computing device (such as, but not limited to, the example integrated training and operator assistance computing device described and illustrated above in connection with FIG. 1 and FIG. 2) may generate a facility deterioration alert indicator.

For example, in response to determining that the predicted facility deterioration indicator does not satisfy the facility deterioration threshold indicator, the computing device determines that the facility is at high risk of deteriorated performance. In such an example, the computing device generates the facility deterioration alert indicator to trigger a warning or an alert to the user to manually intervene.

If, at step/operation 1307, the computing device determines that the predicted facility deterioration indicator satisfies the facility deterioration threshold indicator, the example method 1300 proceeds to step/operation 1311. At step/operation 1311, a computing device (such as, but not limited to, the example integrated training and operator assistance computing device described and illustrated above in connection with FIG. 1 and FIG. 2) may render the runtime facility state indicator and the runtime facility score indicator on a user interface.

For example, the runtime facility state indicator and the runtime facility score indicator may be rendered on a display associated with a user device. In such an example, the runtime facility state indicator and the runtime facility score indicator may visually illustrate the current state of the facility to the user.

Referring back to FIG. 13, subsequent to and/or response to step/operation 1309 and/or step/operation 1311, the example method 1300 proceeds to step/operation 1313 and ends.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

1. An apparatus comprising at least one processor and at least one non-transitory memory comprising a computer program code, the at least one non-transitory memory and the computer program code configured to, with the at least one processor, cause the apparatus to:
receive a plurality of runtime facility process variable indicators and a plurality of runtime derived process metric indicators that are associated with a facility indicator;
receive a facility state tree data object that is associated with the facility indicator and comprises a plurality of facility state tree nodes, wherein each of the plurality of facility state tree nodes corresponds to one of a plurality of facility state indicators;
generate a runtime facility state indicator based at least in part on the plurality of runtime facility process variable indicators, the plurality of runtime derived process metric indicators, and the facility state tree data object;
generate a runtime facility score indicator associated with the runtime facility state indicator based at least in part on the plurality of runtime facility process variable indicators and the plurality of runtime derived process metric indicators; and
generate a remote operator assistance data object associated with the facility indicator based at least in part on the runtime facility state indicator, the runtime facility score indicator, and one or more machine learning models.

2. The apparatus of claim 1, wherein the facility indicator is associated with a plurality of facility unit indicators, wherein the plurality of runtime facility process variable indicators and the plurality of runtime derived process metric indicators are associated with at least one of the plurality of facility unit indicators.

3. The apparatus of claim 1, wherein the plurality of facility state indicators comprises a facility normal state indicator, a facility low throughput state indicator, and a facility upset state indicator.

4. The apparatus of claim 1, wherein, prior to receiving the facility state tree data object, the at least one non-transitory memory and the computer program code are configured to, with the at least one processor, cause the apparatus to:
receive a plurality of historical facility process variable indicators and a plurality of historical derived process metric indicators that are associated with the facility indicator;
generate the facility state tree data object based at least in part on the plurality of historical facility process variable indicators and the plurality of historical derived process metric indicators; and
store the facility state tree data object in a remote operator assistance data repository.

5. The apparatus of claim 4, wherein, when generating the facility state tree data object, the at least one non-transitory memory and the computer program code are configured to, with the at least one processor, cause the apparatus to:
input the plurality of historical facility process variable indicators and the plurality of historical derived process metric indicators to a facility steady state determination machine learning model;
receive, from the facility steady state determination machine learning model, a plurality of steady state facility process variable indicators and a plurality of steady state derived process metric indicators; and
associate each of the plurality of steady state derived process metric indicators with one of the plurality of facility state indicators.

6. The apparatus of claim 4, wherein the plurality of facility state tree nodes comprises a plurality of historical facility score indicators, wherein the at least one non-transitory memory and the computer program code are configured to, with the at least one processor, cause the apparatus to:
generate a historical facility score indicator associated with each of the plurality of facility state indicators based at least in part on the plurality of historical facility process variable indicators and the plurality of historical derived process metric indicators.

7. The apparatus of claim 6, wherein, when generating the historical facility score indicator, the at least one non-transitory memory and the computer program code are configured to, with the at least one processor, cause the apparatus to:
generate a plurality of historical facility state index indicators based at least in part on the plurality of historical facility process variable indicators and the plurality of historical derived process metric indicators;
receive a plurality of historical state index weight indicators associated with the plurality of historical facility state index indicators; and
generate the historical facility score indicator based at least in part on the plurality of historical facility state index indicators and the plurality of historical state index weight indicators.

8. The apparatus of claim 7, wherein the plurality of historical facility state index indicators comprises a historical alarm system performance index indicator, a historical overall operation performance index indicator, a historical field performance index indicator, a historical relative control performance index indicator, and a historical safety performance index indicator.

9. The apparatus of claim 4, wherein the facility state tree data object comprises a plurality of facility state tree branches connecting the plurality of facility state tree nodes.

10. The apparatus of claim 9, the at least one non-transitory memory and the computer program code are configured to, with the at least one processor, cause the apparatus to:
input, to a facility state change prediction machine learning model, the plurality of historical facility process variable indicators and the plurality of historical derived process metric indicators;
receive, from the facility state change prediction machine learning model, a plurality of predicted facility state change likelihood indicators associated with the plurality of facility state indicators; and
generate the plurality of facility state tree branches based at least in part on the plurality of predicted facility state change likelihood indicators.

11. A method, comprising:
receiving a plurality of runtime facility process variable indicators and a plurality of runtime derived process metric indicators that are associated with a facility indicator;
receiving a facility state tree data object that is associated with the facility indicator and comprises a plurality of facility state tree nodes, wherein each of the plurality of facility state tree nodes corresponds to one of a plurality of facility state indicators;
generating a runtime facility state indicator based at least in part on the plurality of runtime facility process variable indicators, the plurality of runtime derived process metric indicators, and the facility state tree data object;
generating a runtime facility score indicator associated with the runtime facility state indicator based at least in part on the plurality of runtime facility process variable indicators and the plurality of runtime derived process metric indicators; and
generating a remote operator assistance data object associated with the facility indicator based at least in part on the runtime facility state indicator, the runtime facility score indicator, and one or more machine learning models.

12. The method of claim 11, wherein the facility indicator is associated with a plurality of facility unit indicators, wherein the plurality of runtime facility process variable indicators and the plurality of runtime derived process metric indicators are associated with at least one of the plurality of facility unit indicators.

13. The method of claim 11, wherein the plurality of facility state indicators comprises a facility normal state indicator, a facility low throughput state indicator, and a facility upset state indicator.

14. The method of claim 11, further comprising:
prior to receiving the facility state tree data object:
receiving a plurality of historical facility process variable indicators and a plurality of historical derived process metric indicators that are associated with the facility indicator;
generating the facility state tree data object based at least in part on the plurality of historical facility process variable indicators and the plurality of historical derived process metric indicators; and
storing the facility state tree data object in a remote operator assistance data repository.

15. The method of claim 14, further comprising:
when generating the facility state tree data object:
inputting the plurality of historical facility process variable indicators and the plurality of historical derived process metric indicators to a facility steady state determination machine learning model;
receiving, from the facility steady state determination machine learning model, a plurality of steady state facility process variable indicators and a plurality of steady state derived process metric indicators; and
associating each of the plurality of steady state derived process metric indicators with one of the plurality of facility state indicators.

16. The method of claim 14, wherein the plurality of facility state tree nodes comprises a plurality of historical facility score indicators, and wherein the method further comprising:
generating a historical facility score indicator associated with each of the plurality of facility state indicators based at least in part on the plurality of historical facility process variable indicators and the plurality of historical derived process metric indicators.

17. The method of claim 16, further comprising:
when generating the historical facility score indicator:
generating a plurality of historical facility state index indicators based at least in part on the plurality of historical facility process variable indicators and the plurality of historical derived process metric indicators;
receiving a plurality of historical state index weight indicators associated with the plurality of historical facility state index indicators; and
generating the historical facility score indicator based at least in part on the plurality of historical facility state index indicators and the plurality of historical state index weight indicators.

18. The method of claim 17, wherein the plurality of historical facility state index indicators comprises a historical alarm system performance index indicator, a historical overall operation performance index indicator, a historical field performance index indicator, a historical relative control performance index indicator, and a historical safety performance index indicator.

19. The method of claim 14, wherein the facility state tree data object comprises a plurality of facility state tree branches connecting the plurality of facility state tree nodes.

20. The method of claim 19, further comprising:
inputting, to a facility state change prediction machine learning model, the plurality of historical facility process variable indicators and the plurality of historical derived process metric indicators;
receiving, from the facility state change prediction machine learning model, a plurality of predicted facility state change likelihood indicators associated with the plurality of facility state indicators; and
generating the plurality of facility state tree branches based at least in part on the plurality of predicted facility state change likelihood indicators.
